(19) United States
(12) Patent Application Publication
(10) Pub. No.: US 2018/0157929 A1
(43) Pub. Date: Jun. 7, 2018

(54) IMAGE EXTRACTION

(71) Applicant: QUALCOMM Incorporated, San Diego, CA (US)

(72) Inventors: Yingyong Qi, San Diego, CA (US); Ning Bi, San Diego, CA (US)

(21) Appl. No.: 15/370,867

(22) Filed: Dec. 6, 2016

(51) Int. Cl. G06K 9/46; G06T 7/00; G06T 1/20

(52) U.S. Cl. CPC G06K 9/4604; G06T 7/0081; G06T 2207/20224; G06T 2207/20144; G06T 1/20

(57) ABSTRACT

A device includes a memory buffer and a processor. The memory buffer is configured to store background image-blocks corresponding to image-blocks of a plurality of image frames of a video stream. The processor is configured to partition a particular image frame of the video stream into multiple image-blocks. The processor is also configured to generate a predicted background image-block based on one or more of the background image-blocks. The processor is further configured to determine a background prediction error based on a comparison of the predicted background image-block and a corresponding image-block of the particular image frame. The processor is also configured, based on determining that the background prediction error is greater than a threshold, to extract from the image-block at least one of a background image-block corresponding to the image-block or a foreground image-block corresponding to the image-block.

### I. FIELD

The present disclosure is generally related to image extraction.

### II. DESCRIPTION OF RELATED ART

Advances in technology have resulted in smaller and more powerful computing devices. For example, there exist a variety of portable personal computing devices, including wireless telephones such as mobile and smart phones, tablets and laptop computers that are small, lightweight, and easily carried by users. These devices can communicate voice and data packets over wireless networks. Further, many such devices incorporate additional functionality such as a digital still camera, a digital video camera, a digital recorder, and an audio file player. Also, such devices can process executable instructions, including software applications, such as a web browser application, that can be used to access the Internet. As such, these devices can include significant computing capabilities.

Some of these devices may be configured to process images captured by associated cameras. For example, a device may perform background subtraction on a received image frame. Background subtraction is a technique to distinguish a foreground portion from a background portion of the image frame. Background subtraction may be used to detect a moving object (e.g., in the foreground portion) represented in a video stream that includes the image frame. Background subtraction can be challenging because it can be difficult to distinguish changes associated with the moving object from changes in the background due to variable in light conditions, wind conditions, etc. As image size and resolution increases, processing the image frame for background subtraction becomes increasingly computationally expensive and time-consuming (e.g., the complexity of matrix computations may increase exponentially with increases in the image size).

### III. SUMMARY

In a particular aspect, a device includes a memory buffer and a processor. The memory buffer is configured to store background image-blocks corresponding to image-blocks of a plurality of image frames of a video stream. The processor is configured to partition a particular image frame of the video stream into multiple image-blocks. The processor is also configured to generate a predicted background image-block based on one or more of the background image-blocks. The processor is further configured to determine a background prediction error based on a comparison of the predicted background image-block and a corresponding image-block of the particular image frame. The processor is also configured, based on determining that the background prediction error is greater than a threshold, to extract from the image-block at least one of a background image-block corresponding to the image-block or a foreground image-block corresponding to the image-block.

In another particular aspect, a method of video processing includes storing, at a memory buffer of a device, background image-blocks corresponding to image-blocks of a plurality of image frames of a video stream. The method also includes generating, at the device, a predicted background image-block based on one or more of the background image-blocks. The method further includes determining, at the device, a background prediction error based on a comparison of the predicted background image-block and a corresponding image-block of the particular image frame. The method also includes determining, at the device, that the background prediction error is greater than a threshold. The method further includes, based on determining that the background prediction error is greater than the threshold, extracting from the image-block at least one of a background image-block corresponding to the image-block or a foreground image-block corresponding to the image-block.

In another particular aspect, a computer-readable storage device stores instructions that, when executed by a processor, cause the processor to perform operations including storing, at a memory buffer, background image-blocks corresponding to image-blocks of a plurality of image frames of a video stream. The operations also include partitioning a particular image frame of the video stream into multiple image-blocks. The operations further include generating a predicted background image-block based on one or more of the background image-blocks. The operations also include determining a background prediction error based on a comparison of the predicted background image-block and a corresponding image-block of the particular image frame. The operations further include determining that the background prediction error is greater than a threshold. The operations also include, based on determining that the background prediction error is greater than the threshold, extracting from the image-block at least one of a background image-block corresponding to the image-block or a foreground image-block corresponding to the image-block.

In another particular aspect, an apparatus includes means for storing background image-blocks corresponding to image-blocks of a plurality of image frames of a video stream. The apparatus also includes means for extracting from an image-block of a particular image frame of the video stream at least one of a background image-block corresponding to the image-block or a foreground image-block corresponding to the image-block based on determining that a background prediction error is greater than a threshold. The background prediction error is based on a comparison of the image-block and a predicted background image-block of the image-block. The predicted background image-block is based on one or more of the background image-blocks.

Other aspects, advantages, and features of the present disclosure will become apparent after review of the entire application, including the following sections: Brief Description of the Drawings, Detailed Description, and the Claims.

### IV. BRIEF DESCRIPTION OF THE DRAWINGS

FIG. 1 is a block diagram of a particular illustrative aspect of a system operable to perform image extraction;

FIG. 2 is a flow chart of a particular method of image extraction;

FIG. 3 is a diagram of an aspect of a prediction-based background image-block generator of the system of FIG. 1;

FIG. 4 is a diagram of an aspect of a background/foreground image-block generator of the prediction-based background image-block generator of FIG. 3;

FIG. 5 is a flow chart of another particular method of image extraction;

FIG. 6 is a diagram of another aspect of a prediction-based background image-block generator of the system of FIG. 1;

FIG. 7 is a flow chart of another particular method of image extraction; and

FIG. 8 is a block diagram of a device that is operable to perform image extraction in accordance with the systems and methods of FIGS. 1-7.

### V. DETAILED DESCRIPTION

Systems and methods of image extraction are disclosed. The described image extraction techniques may be performed on a video stream (e.g., a stream of image frames from a video camera), a video stream accessed via a network, or on video data stored in a memory. The image extraction techniques include partitioning an image frame of a plurality of image frames (of a video stream or of video data) into multiple image-blocks. Each image-block represents a portion (e.g., a subset) of the image frame. The image-blocks of a particular image frame may be individually analyzed using a first process (e.g., a lower computational cost process, as described further below). Some of the image-blocks may subsequently be processed using a second process (e.g., a higher computational cost process, as described further below). Computational resources are conserved by generally reserving the second process for use on image-blocks that cannot be reliably processed using only the first process, such as image-blocks that fail to satisfy particular processing criteria. The image-blocks of the particular image frame may be analyzed (using the first process, the second process, or both) concurrently or in parallel and independently of one another. For ease of reference herein, the terms current and previous are used to distinguish data that is being analyzed (e.g., current data) and data that has been analyzed (e.g., previous data). In this context, current and previous refers only to the order of analysis and does not imply any particular order within a video stream. Further, “current” does not imply real-time processing of the “current” data. For example, a “current image frame” corresponds to an image frame of the video stream that is being analyzed as distinct from a “previous image frame” which has already been analyzed. Likewise, a “current image-block” corresponds to an image-block of the current image frame, and a “previous image-block” refers to an image-block of a previously-analyzed image frame of the video stream. The previously-analyzed image frame may be prior to or subsequent to the current image frame in the video stream.

The first process (e.g., the lower computational cost process) includes generating a predicted background image-block based on a previous image-block of at least one previously-analyzed image frame. If the predicted background image-block is substantially similar to a current image-block of the current image frame, the predicted background image-block may be designated as a background image-block corresponding to the current image-block and a difference image may be designated as a foreground image-block corresponding to the current image-block. The difference image may correspond to a difference (if any) between the predicted background image-block and the current image-block. If the predicted background image-block is not substantially similar to the current image-block, the second process (e.g., the higher computational cost process) may be performed on the current image-block to extract the background image-block and the foreground image-block corresponding to the current image-block. The second process includes background/foreground separation techniques (e.g., image decomposition).

Background prediction may be performed using previous background image-blocks corresponding to at least a threshold number (e.g., a minimum number) of previously-analyzed image frames of the video stream. During an initialization phase of processing the video stream, e.g., when background image-blocks corresponding to fewer than the threshold number of image frames are stored in an image buffer, image decomposition may be used to generate a background image-block corresponding to a current image-block of the current image frame. The background image-block may be stored in the image buffer. Subsequent to the initialization phase, a predicted background image-block may be generated based on the background image-block (e.g., a previous background image-block) stored in the image buffer.

A predicted background image-block may be generated by performing a prediction analysis (e.g., a linear regression analysis) on one or more previous background image-blocks stored in the image buffer. A background prediction error (e.g., a difference image-block) may be determined based on a difference between the predicted background image-block and a corresponding current image-block of the current image frame. When the background prediction error is not large, the prediction-based BG IB generator may designate the predicted background image-block as a background image-block corresponding to the current image-block and may designate the background prediction error (e.g., the difference image-block) as a foreground image-block corresponding to the current image-block. Otherwise, image decomposition (e.g., matrix decomposition) may be applied to extract a background image-block of the current image-block and a foreground image-block of the current image-block. For example, a matrix (X) may be generated based on the current image-block and previous image-blocks of previously-analyzed image-frames of the video stream. The background image-block (B) and the foreground image-block (F) may be generated by decomposing the matrix (e.g., X=B+F). The background image-block and the foreground image-block may be stored in the image buffer and a next image frame of the video stream may be processed.

Because generating the predicted background image-block by performing the prediction analysis (e.g., a linear regression analysis) may be computationally less expensive than image decomposition (e.g., matrix decomposition), processing resources may be conserved by using the predicted background image-block for a current image-block having a small background prediction error and reserving image decomposition for initialization and for a current image-block that has a large background prediction error. In addition, processing resources to perform image decomposition for an individual image-block may be reduced as compared to decomposition for the entire image frame. Analyzing some or all of the image-blocks of the current image frame in parallel may also reduce latency for object detection, tracking, and recognition/surveillance monitoring applications.

Particular aspects of the present disclosure are described below with reference to the drawings. In the description, common features are designated by common reference numbers. As used herein, various terminology is used for the purpose of describing particular implementations and is not intended to be limiting. For example, the singular forms “a,” “an,” and “the” are intended to include the plural forms as well, unless the context clearly indicates otherwise. It may be further understood that the terms “comprises” and “comprising” may be used interchangeably with “includes” or “including.” Additionally, it will be understood that the term “wherein” may be used interchangeably with “where.” As used herein, an ordinal term (e.g., “first,” “second,” “third,” etc.) used to modify an element, such as a structure, a component, an operation, etc., does not by itself indicate any priority or order of the element with respect to another element, but rather merely distinguishes the element from another element having a same name (but for use of the ordinal term). As used herein, the term “subset” refers to a grouping of one or more elements, and the term “plurality” refers to multiple elements.

As used herein, “coupled” may include “communicatively coupled,” “electrically coupled,” or “physically coupled,” and combinations thereof. Two devices (or components) may be coupled (e.g., communicatively coupled, electrically coupled, or physically coupled) directly or indirectly via one or more other devices, components, wires, buses, networks (e.g., a wired network, a wireless network, or a combination thereof), etc. Two devices (or components) that are electrically coupled may be included in the same device or in different devices and may be connected via electronics, one or more connectors, or inductive coupling, as illustrative, non-limiting examples. In some implementations, two devices (or components) that are communicatively coupled, such as in electrical communication, may send and receive electrical signals (digital signals or analog signal) directly or indirectly, such as via one or more wires, buses, networks, etc.

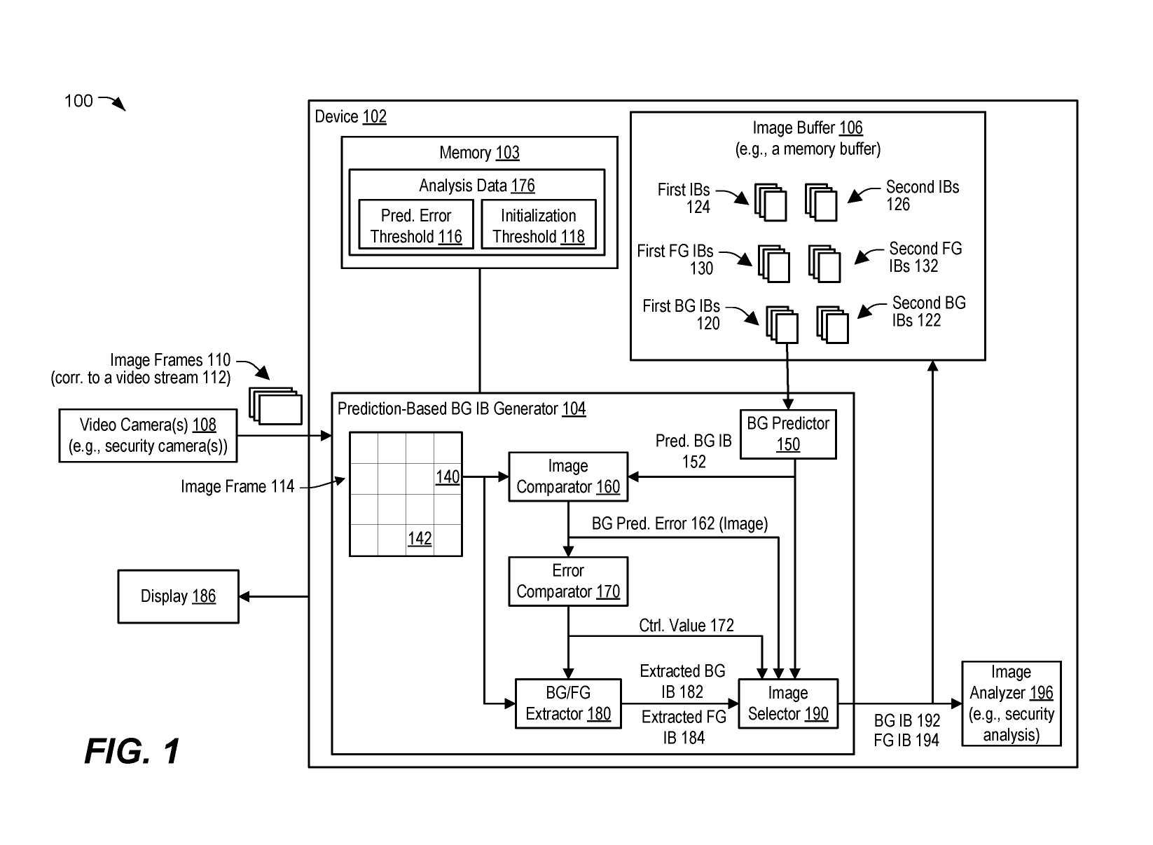

Referring to FIG. 1, a particular illustrative aspect of a system is disclosed and generally designated 100. The system 100 includes a device 102 configured to receive and process a video stream 112 including or corresponding to a plurality of image frames 110. In some implementations, the device 102 may retrieve the video stream 112 from another device (not shown) such as a memory device or a computing device. In other implementations, as illustrated in FIG. 1, the device 102 may be coupled to an image capture device (e.g., one or more video cameras 108) that provides the video stream 112. For example, the video camera(s) 108 (e.g., one or more security cameras) may be included in a security system (e.g., a surveillance system). In another example, the video camera(s) 108 are included in a vehicle, such as a car or an aircraft (e.g., an unmanned aerial vehicle or a manned aerial vehicle). In yet another example, the video camera(s) 108 are included in a medical diagnostic device. In still other examples, the video camera(s) 108 are included in any device that is configured to perform background separation on images captured by the video camera(s) 108. The device 102 may be coupled to a display 186. The display 186 may be configured to output one or more messages (e.g., security alerts), one or more image frames based on the video stream 112, or a combination thereof.

The device 102 includes a prediction-based BG IB generator 104 (e.g., a processor) coupled to an image buffer 106 (e.g., a memory buffer), an image analyzer 196, a memory 103, or a combination thereof. The memory 103 is configured to store analysis data 176. The analysis data 176 may include a prediction error threshold 116, an initialization threshold 118, or both. The prediction error threshold 116 may be based on a default value, a configuration setting, or both. For example, the prediction error threshold 116 may be based on an input received from a user that designates use of the default value, the configuration setting, or both. The prediction error threshold 116 may indicate an amount of difference between a predicted background image-block and a current image-block that is tolerable to consider the predicted background image-block substantially similar to the current image-block. For example, the prediction error threshold 116 may indicate a threshold number (or percentage) of pixels (e.g., 15%) having a particular characteristic. To illustrate, a pixel of the current image-block may have the particular characteristic if a difference between a first pixel value of the pixel and a second pixel value of a corresponding pixel of the predicted background image-block is greater than a difference threshold.

The initialization threshold 118 may be based on a default value, a configuration setting, or both. For example, the initialization threshold 118 may be based on an input received from a user that designates use of the default value, the configuration setting, or both. The initialization threshold 118 may indicate that background image-blocks of a particular number (e.g., a minimum number) of previously-analyzed image frames (e.g., prior image frames) are to be used to perform prediction analysis to generate a predicted background image-block.

The image buffer 106 is configured to store data representing IBs, data representing foreground (FG) IBs, data representing background (BG) IBs, or a combination thereof. For example, in FIG. 1, the data representing IBs includes one or more first IBs 124 and one or more second IBs 126 associated with a set of previously-analyzed image frames of the video stream 112. The set of previously-analyzed image frames precedes (or succeeds) in the video stream 112 a current image frame (e.g., an image frame 114) being processed. Each of the first IBs 124 may have a first location (e.g., row 2 and column 4) in a corresponding image frame of the set of previously-analyzed image frames. Each of the second IBs 126 may have a second location (e.g., row 4 and column 3) in a corresponding image frame of the set of previously-analyzed image frames.

Also in the example illustrated in FIG. 1, the data representing FG IBs includes one or more first FG IBs 130 associated with the first IBs 124, and one or more second FG IBs 132 associated with the second IBs 126. Further, in the example illustrated in FIG. 1, the data representing BG IBs includes one or more first BG IBs 120 associated with the first IBs 124 and one or more second BG IBs 122 associated with the second IBs 126.

A BG IB of an IB may include one or more BG portions of the IB, whereas a FG IB of the IB may include one or more FG portions of the IB. A BG portion of an IB of a current image frame may be substantially similar to a BG portion of a corresponding IB of a previously-analyzed image frame of the video stream 112. A FG portion of the IB of the current image frame may be different (e.g., not substantially similar) from a FG portion of the corresponding IB.

Although, operation of the system 100 is described herein with reference to the image frame 114, it should be understood that similar operations may be performed on a plurality of the image frames 110 of the video stream 112. For example, similar operations may be performed on each of the image frames 110. As another example, similar operations may be performed on a subset (e.g., every other image frame) of the image frames 110.

The prediction-based BG IB generator 104 is configured to partition the image frame 114 to generate a plurality of IBs, such as IB 140 and IB 142. For example, the prediction-based BG IB generator 104 may partition the image frame 114 into a first number of columns (e.g., 4 columns) and a second number of rows (e.g., 4 rows) of IBs. To illustrate, the IB 140 may correspond to a first column (e.g., column 4) and a first row (e.g., row 2) of the IBs, and the IB 142 may correspond to a second column (e.g., column 3) and a second row (e.g., row 4) of the IBs. The first number may be the same as or distinct from the second number.

Although FIG. 1 illustrates the image frame 114 partitioned into rectangular, non-overlapping, identically-shaped, equal-sized IBs, in other implementations the image frame 114 may be partitioned in another manner. For example, the image frame 114 may be partitioned into IBs having at least one non-rectangular IB, at least two overlapping IBs, at least one IB with a first shape that is distinct from a second shape of another IB, at least one IB having a first size that is distinct from a second size of another IB, or a combination thereof.

The prediction-based BG IB generator 104 is further configured to process each IB to generate at least one of a BG IB or a FG IB. For example, the IB 140 may be processed to generate at least one of a BG IB 192 or a FG IB 194 corresponding to the IB 140, as described herein. In a particular aspect, multiple image-blocks of the image frame 114 are processed concurrently or in parallel.

In a particular aspect, the prediction-based BG IB generator 104 partitions the image frame 114 into unequal-sized IBs, as described herein. The prediction-based BG IB generator 104 determines that a subset of the image frames 110 has been previously analyzed. The prediction-based BG IB generator 104 may determine that predicted BG IBs are designated as BG IBs corresponding to IBs of a first portion (e.g., a top half) of the subset of the image frames 110. Designation of the predicted BG IBs as the BG IBs may indicate that the first portion of the subset of the image frames 110 remains relatively unchanged from one image frame to the next. The prediction-based BG IB generator 104 may determine that extracted BG IBs are designated as BG IBs corresponding to IBs of a second portion (e.g., a bottom half) of the subset of the image frames 110. Designation of the extracted BG IBs as the BG IBs may indicate that the second portion of the subset of the image frames 110 changes more frequently. For example, the first portion may correspond to buildings behind a street and the second portion may correspond to the street with some traffic. The prediction-based BG IB generator 104, in response to determining that the first portion remains relatively unchanged and that the second portion changes more frequently, partitions the first portion (e.g., the top half) of the image frame 114 into a first number of IBs (e.g., a single IB) and partitions the second portion (e.g., the bottom half) of the image frame 114 into a second number of IBs (e.g., multiple IBs). The second number may be greater than the first number. The IBs corresponding to the second portion of the image frame 114 may be smaller than the IB(s) corresponding to the first portion of the image frame 114. Performing image decomposition of the smaller IBs of the second portion substantially in parallel with each other and generating fewer predicted BG IBs (e.g., a single BG IB) corresponding to the first portion may conserve resources (e.g., processing time, computational cycles, or both).

The prediction-based BG IB generator 104 may be configured to process the IBs of the image frame 114 independently of each other. For example, the prediction-based BG IB generator 104 may process the IB 140 independently of the IB 142, as described herein. In a particular aspect, the device 102 may include multiple copies of the prediction-based BG IB generator 104 and each of the copies of the prediction-based BG IB generator 104 may process a respective IB of the image frame 114. For example, the copies of the prediction-based BG IB generator 104 may process two or more of the IBs of the image frame 114 substantially in parallel with each other. Processing two or more of the IBs substantially in parallel with each other may reduce processing time associated with processing the image frame 114.

The prediction-based BG IB generator 104 includes at least one of a BG predictor 150, an image comparator 160, an error comparator 170, a background/foreground (BG/FG) extractor 180, or an image selector 190. The BG predictor 150 may be configured to generate a predicted BG IB based on previous BG IBs having a particular location in corresponding image frames. For example, the BG predictor 150 may generate a predicted BG IB 152 based on the first BG IBs 120 stored in the image buffer 106 and associated with a first location (e.g., row 2 and column 4) of corresponding image frames, as described herein. Similarly, the BG predictor 150 may generate a second predicted BG IB based on the second BG IBs 122 stored in the image buffer 106 and associated with a second location (e.g., row 4 and column 3) of corresponding image frames.

In a particular aspect, the device 102 may include multiple copies of the prediction-based BG IB generator 104. The device 102 may activate a number of copies of the prediction-based BG IB generator 104 to process a subset of IBs of the image frame 114. Each of the activated copies of the prediction-based BG IB generator 104 may be associated with a particular location. For example, a first activated copy of the prediction-based BG IB generator 104 may be associated with a first location (e.g., row 2 and column 4) and a second activated copy of the prediction-based BG IB generator 104 may be associated with a second location (e.g., row 4 and column 3). Each of the activated copies of the prediction-based BG IB generator 104 may include an activated copy of the BG predictor 150. For example, the first activated copy of the prediction-based BG IB generator 104 may include a first activated copy of the BG predictor 150, whereas the second activated copy of the prediction-based BG IB generator 104 may include a second activated copy of the BG predictor 150. Each activated copy of the BG predictor 150 may generate a predicted BG IB based on BG IBs associated with the same location as the corresponding activated copy of the prediction-based BG IB generator 104. For example, the first activated copy of the BG predictor 150 may generate the predicted BG IB 152 based on the first BG IBs 120 associated with the same location (e.g., the first location) as the first activated copy of the prediction-based BG IB generator 104. Similarly, the second activated copy of the BG predictor 150 may generate a second predicted BG IB based on the second BG IBs 122 associated with the same location (e.g., the second location) as the second activated copy of the prediction-based BG IB generator 104.

Each of the predicted BG IBs may correspond to an expected BG image-block. For example, a predicted BG IB may be an expected BG image-block based on a continuation of a trend of changes (if any) in corresponding BG IBs associated with previously-analyzed image frames of the video stream 112. To illustrate, the BG predictor 150 may determine the predicted BG IB 152 by performing a prediction analysis on the first BG IBs 120. In a particular aspect, the BG predictor 150 generates the predicted BG IB 152 as a copy of a previous BG IB of the first BG IBs 120 in response to determining that there is no (or little) change between each of the first BG IBs 120. Alternatively, the BG predictor 150 determines a trend of changes across the first BG IBs 120 (e.g., a change in light conditions) and generates the predicted BG IB 152 by applying changes based on the trend to a previous BG IB of the first BG IBs 120. The previous BG IB may correspond to an IB of an image frame that is most recently analyzed prior to the image frame 114. The BG predictor 150 may provide the predicted BG IB (e.g., the predicted BG IB 152) to the image comparator 160, the image selector 190, or both.

The image comparator 160 may be configured to generate a BG prediction error 162 (e.g., a difference image) based on a comparison of a predicted BG IB (e.g., the predicted BG IB 152) and a corresponding IB (e.g., the IB 140) of the image frame 114. For example, the BG prediction error 162 may correspond to an image indicating differences between the IB 140 and the predicted BG IB 152. To illustrate, the image comparator 160 may perform a pixel-by-pixel subtraction operation to determine a pixel value difference between each pixel of the predicted BG IB 152 and the corresponding pixel of the IB 140. The BG prediction error 162 may represent the difference value for each pixel. The image comparator 160 may provide the BG prediction error 162 to the error comparator 170, the image selector 190, or both.

The error comparator 170 may be configured to generate a control value 172 in response to determining whether the BG prediction error 162 satisfies the prediction error threshold 116, as described herein. For example, a first value (e.g., 0) of the control value 172 may indicate the IB 140 is relatively similar to (e.g., the same as) the predicted BG IB 152, whereas a second value (e.g., 1) of the control value 172 may indicate the IB 140 is not relatively similar to the predicted BG IB 152. The error comparator 170 may provide the control value 172 to the BG/FG extractor 180, the image selector 190, or both.

The BG/FG extractor 180 may be configured to selectively generate at least one of an extracted BG IB 182 or an extracted FG IB 184 from the IB 140. For example, the BG/FG extractor 180 may be configured, in response to determining that the control value 172 has the second value (e.g., 1) indicating that the IB 140 is not relatively similar to the predicted BG IB 152, to generate at least one of the extracted BG IB 182 or the extracted FG IB 184 based on the IB 140, as described herein. The BG/FG extractor 180 may provide at least one of the extracted BG IB 182 or the extracted FG IB 184 to the image selector 190. Alternatively, the BG/FG extractor 180 may, in response to determining that the control value 172 has the first value (e.g., 0) indicating that the IB 140 is relatively similar to the predicted BG IB 152, refrain from processing the IB 140. The BG/FG extractor 180 may conserve resources (e.g., time and processing cycles) by refraining from generating the extracted BG IB 182 and the extracted FG IB 184 when the IB 140 is relatively similar to the predicted BG IB 152. The BG/FG extractor 180 may thus selectively perform the more expensive image decomposition in response to determining that the IB 140 is not relatively similar to the predicted BG IB 152.

The image selector 190 may be configured to select, based on the control value 172, the predicted BG IB 152 or the extracted BG IB 182 as the BG IB 192. Similarly, the image selector 190 may be configured to select, based on the control value 172, the BG prediction error 162 (e.g., the difference image) or the extracted FG IB 184 as the FG IB 194. For example, the image selector 190 may, in response to determining that the control value 172 has the first value (e.g., 0) indicating that the IB 140 is relatively similar to the predicted BG IB 152, select the predicted BG IB 152 as the BG IB 192, the BG prediction error 162 (e.g., the difference image) as the FG IB 194, or both. As another example, the image selector 190 may, in response to determining that the control value 172 has the second value (e.g., 1) indicating that the IB 140 is not relatively similar to the predicted BG IB 152, select the extracted BG IB 182 as the BG IB 192, the extracted FG IB 184 as the FG IB 194, or both.

The prediction-based BG IB generator 104 may be configured to store at least one of the BG IB 192 or the FG IB 194 in the image buffer 106. In a particular aspect, the prediction-based BG IB generator 104 provides at least one of the BG IB 192 or the FG IB 194 to the image analyzer 196.

The image analyzer 196 may perform various operations based on at least one of the BG IB 192 or the FG IB 194. For example, the image analyzer 196 may determine whether one or more characteristics of the FG IB 194, one or more characteristics of the BG IB 192, or a combination thereof, satisfy at least one criterion, as described herein. The image analyzer 196 may, in response to determining that at least one criterion (e.g., an alert criterion) is satisfied, send an alert message to a communication device, provide an alert message to the display 186, activate a lock, perform another operation, or a combination thereof. In a particular aspect, the image analyzer 196 may generate a combined FG image by combining the FG IBs corresponding to the image frame 114. The image analyzer 196 may provide the FG IB 194, the BG IB 192, the IB 140, the image frame 114, the combined FG image, or a combination thereof, to the display 186 or to another device. In a particular aspect, the image analyzer 196 may perform object detection, object tracking, or both, based on the FG IB 194 (or the combined FG image).

During operation, the device 102 may receive the video stream 112 from the video camera(s) 108. The video stream 112 includes the image frames 110. The prediction-based BG IB generator 104 may process one or more other image frames of the image frames 110 prior to processing the image frame 114. The prediction-based BG IB generator 104 may partition the one or more previously-analyzed image frames of the image frames 110 to generate a plurality of IBs. For example, the prediction-based BG IB generator 104 partitions a first image frame to generate a first set of IBs and partitions a second image frame to generate a second set of IBs.

The plurality of IBs generated from the one or more previously-analyzed image frames may be grouped based on IB location. For example, the prediction-based BG IB generator 104 may generate first IBs that are at a first location (e.g., column 4 and row 2) of the previously-analyzed image frames and second IBs that are at a second location (e.g., column 3 and row 4) of the previously analyzed image frames. The first IBs may include the first IBs 124 corresponding to a subset of the previously-analyzed image frames. The second IBs may include the second IBs 126 corresponding to the subset of the previously-analyzed image frames. For example, the subset of the previously-analyzed image frames may include a first image frame and a second image frame. The first IBs 124 may include an IB of the first image frame and an IB of the second image frame. The IB of the first image frame may have the first location (e.g., column 4 and row 2) in the first image frame and the IB of the second image frame may have the first location (e.g., column 4 and row 2) in the second image frame. Similarly, the second IBs 126 may include another IB of the first image frame and another IB of the second image frame. The IB of the first image frame may have the second location (e.g., column 3 and row 4) in the first image frame and the IB of the second image frame may have the second location (e.g., column 3 and row 4) in the second image frame.

The prediction-based BG IB generator 104 may generate FG image-blocks, BG image-blocks, or a combination thereof, corresponding to the plurality of IBs. For example, the prediction-based BG IB generator 104 generates the first FG IBs 130, the first BG IBs 120, or a combination thereof, based on the first IBs 124, as described herein. Similarly, the prediction-based BG IB generator 104 generates the second FG IBs 132, the second BG IBs 122, or a combination thereof, based on the second IBs 126.

The prediction-based BG IB generator 104 stores the plurality of IBs, the FG image-blocks, the BG image-blocks, or a combination thereof, corresponding to the previously-analyzed image frames in the image buffer 106. For example, the prediction-based BG IB generator 104 stores the first IBs 124, the second IBs 126, the first FG IBs 130, the first BG IBs 120, the second FG IBs 132, the second BG IBs 122 corresponding to the subset of the image frames 110, or a combination thereof, in the image buffer 106. The prediction-based BG IB generator 104 may store, at the image buffer 106, the memory 103, or both, a first location identifier indicating that the first IBs 124, the first FG IBs 130, the first BG IBs 120, or a combination thereof, are associated with the first location. Similarly, the prediction-based BG IB generator 104 may store, at the image buffer 106, the memory 103, or both, a second location identifier indicating that the second IBs 126, the second FG IBs 132, the second BG IBs 122, or a combination thereof, are associated with the second location.

The prediction-based BG IB generator 104 may partition the image frame 114 of the image frames 110 into IBs including at least one of the IB 140, the IB 142, or one or more additional IBs. As illustrated in FIG. 1, the IB 140 has the first location (e.g., column 4 and row 2) in the image frame 114. The IB 142 has the second location (e.g., column 3 and row 4) in the image frame 114. The prediction-based BG IB generator 104 may process one or more of the plurality of IBs independently of other IBs of the plurality of IBs. For example, the prediction-based BG IB generator 104 processes the IB 140, as described herein, independently of the IB 142. The prediction-based BG IB generator 104 may select the subset of the image frames 110 (e.g., 5 image frames analyzed prior to the image frame 114) based on a configuration setting. For example, the configuration setting may indicate that the image extraction is to be performed based on previously-analyzed image frames of the video stream 112. The configuration setting may indicate a count of image frames (e.g., 5 image frames) to be used for performing image extraction. The prediction-based BG IB generator 104 may select the subset of the image frames 110 in response to determining that a size of the subset is equal to the count of the image frames indicated by the configuration setting.

In a particular aspect, the configuration setting may indicate whether the image extraction is to be performed on the most recently analyzed image frames, on every nth frame of the most recently analyzed image frames, or another selection criterion. For example, the configuration setting may indicate that image extraction is to be performed based on a count (e.g., 3) of image frames and based on Nth (e.g., N=5) frames. The prediction-based BG IB generator 104 may sort the image frames from most recently analyzed to least recently analyzed and may include image frames in the subset having sorted positions corresponding to multiples of N such that a size of the subset is equal to the count. For example, the subset may include a 5th most recently analyzed image frame, a 10th most recently analyzed image frame, and a 15th most recently analyzed image frame.

The BG predictor 150 may select BG IBs corresponding to the selected subset of the image frames 110 to generate predicted BG IBs. For example, the BG predictor 150 may select the first BG IBs 120 in response to determining that the first BG IBs 120 correspond to the selected subset of the image frames 110. The BG predictor 150 may generate the predicted BG IB 152 based on the first BG IBs 120. For example, the BG predictor 150 performs a prediction analysis (e.g., a linear regression) based on the first BG IBs 120 to determine the predicted BG IB 152. The BG predictor 150 may determine a value of a pixel at a particular location of the predicted BG IB 152 by performing a prediction analysis (e.g., a linear regression) on pixel values of pixels of the first BG IBs 120. The prediction analysis may indicate a trend of changes across the first BG IBs 120 (e.g., a change in light conditions). The BG predictor 150 may generate the predicted BG IB 152 based on a continuation of the trend of changes in the first BG IBs 120. For example, the BG predictor 150 may determine a pixel value of a pixel at a particular location of the predicted BG IB 152 based on pixel values of pixels at the particular location in the first BG IBs 120. To illustrate, a first pixel of a first BG image of the first BG IBs 120 indicates a first pixel value. A second pixel of a second BG image of the first BG IBs 120 indicates a second pixel value. The first pixel has a particular location (e.g., coordinates) in the first BG image. The second pixel has the same particular location in the second BG image. The BG predictor 150 may predict a pixel value of a pixel at the particular location of the predicted BG IB 152 by performing a prediction analysis (e.g., a linear regression) on the first pixel value, the second pixel value, pixel values of pixels at the particular location in other BG IBs of the first BG IBs 120, or a combination thereof.

In a particular aspect, the BG predictor 150 may determine a pixel value of a pixel at a particular location of the predicted BG IB 152 based on pixel values of pixels at one or more locations in the first BG IBs 120, pixel values of pixels of the predicted BG IB 152 that have already been determined, or a combination thereof. For example, the BG predictor 150 may, during a first iteration, determine a pixel value of a pixel at a particular location of the predicted BG IB 152 based on pixel values of pixels at one or more locations (e.g., all pixels) in the first BG IBs 120. The BG predictor 150 may, during a second iteration, update a pixel value of the pixel at the particular location of the predicted BG IB 152 based on pixel values of one or more pixels at one or more locations (e.g., neighboring pixels or all pixels) of the predicted BG IB 152.

In a particular aspect, the BG predictor 150 determines a trend of changes in the first BG IBs 120 and generates the predicted BG IB 152 by applying changes based on the trend to a previous BG IB of the first BG IBs 120. The previous BG IB may correspond to an IB of an image frame that is most recently analyzed prior to the image frame 114. The predicted BG IB 152 may correspond to a background of the IB 140 if the IB 140 is similar to the first IBs 124 or if changes in the IB 140 relative to the first IBs 124 continue a trend of changes in the first IBs 124.

The prediction-based BG IB generator 104 may determine that the predicted BG IB 152 is associated with a first location (e.g., column 4 and row 2) in response to determining that the first BG IBs 120 are associated with the first location. The prediction-based BG IB generator 104 may store, at the image buffer 106, the memory 103, or both, a first location identifier indicating that the predicted BG IB 152 is associated with the first location (e.g., column 4 and row 2). The BG predictor 150 provides the predicted BG IB 152 to the image comparator 160, the image selector 190, or both.

The image comparator 160, in response to determining that the first BG IBs 120 are associated with the same location (e.g., the first location) as the IB 140, selects the IB 140 of the image frame 114. For example, the image comparator 160 selects the IB 140 in response to determining that the location identifier associated with the predicted BG IB 152 indicates the same location (e.g., the first location) as indicated by a location identifier associated with the IB 140. The image comparator 160 may generate the BG prediction error 162 (e.g., a difference image) based on a comparison of the predicted BG IB 152 and the IB 140. For example, the BG prediction error 162 corresponds to a difference between the predicted BG IB 152 and the IB 140. To illustrate, the BG prediction error 162 corresponds to an image including a plurality of pixels. Each pixel has a value indicating a difference between a first pixel value of a corresponding pixel of the predicted BG IB 152 and a second pixel value of a corresponding pixel of the IB 140. The image comparator 160 provides the BG prediction error 162 to the error comparator 170, the image selector 190, or both.

If the IB 140 is similar to the predicted BG IB 152, pixel values indicated by the BG prediction error 162 are low. If the IB 140 is not similar to the predicted BG IB 152, at least some (e.g., all) pixel values indicated by the BG prediction error 162 are high. For example, if the first BG IBs 120 of the previously-analyzed image frames represent a scene of a field and the image frame 114 represents a ball moving into the scene at a location corresponding to the IB 140, the pixel values indicated by the BG prediction error 162 are high. If the image frame 114 represents the scene of the field without the ball, the pixel values indicated by the BG prediction error 162 are low.

The error comparator 170 may determine the control value 172 based on a comparison of the BG prediction error 162 and the prediction error threshold 116. For example, the error comparator 170 determines a difference value based on the BG prediction error 162. The difference value may include a mean pixel value of the BG prediction error 162, a median pixel value of the BG prediction error 162, a sum of pixel values of the BG prediction error 162, a count of pixels of the BG prediction error 162 having a pixel value over a difference threshold, or another value based on the BG prediction error 162. The prediction error threshold 116 may indicate a threshold number (or percentage) of pixels, a threshold mean pixel value, a threshold median pixel value, a threshold pixel sum value, or another threshold value. The error comparator 170 may determine whether the BG prediction error 162 satisfies the prediction error threshold 116. For example, the error comparator 170 determines that the BG prediction error 162 satisfies the prediction error threshold 116 in response to determining that the difference value satisfies (e.g., is less than or equal to) the prediction error threshold 116. As another example, the error comparator 170 determines that the BG prediction error 162 fails to satisfy the prediction error threshold 116 in response to determining that the difference value fails to satisfy (e.g., is greater than) the prediction error threshold 116.

The error comparator 170 assigns a first value (e.g., 0) to the control value 172 in response to determining that the BG prediction error 162 satisfies the prediction error threshold 116. The first value (e.g., 0) of the control value 172 may indicate that the IB 140 is substantially similar to the predicted BG IB 152. Alternatively, the error comparator 170 assigns a second value (e.g., 1) to the control value 172 in response to determining that the BG prediction error 162 fails to satisfy the prediction error threshold 116. The second value (e.g., 1) of the control value 172 may indicate that the IB 140 is not substantially similar to the predicted BG IB 152. The error comparator 170 provides the control value 172 to the BG/FG extractor 180, the image selector 190, or both.

The BG/FG extractor 180 selectively generates the extracted BG IB 182, the extracted FG IB 184, or both, based on the control value 172. For example, the BG/FG extractor 180 may, in response to determining that the control value 172 has the second value (e.g., 1), generates the extracted BG IB 182, the extracted FG IB 184, or both, based on the IB 140. For example, the BG/FG extractor 180 performs image decomposition techniques (e.g., matrix decomposition) on the IB 140 when the control value 172 has the second value (e.g., 1) to generate the extracted BG IB 182, the extracted FG IB 184, or both. To illustrate, the BG/FG extractor 180 generates a matrix based on the IB 140 and the first IBs 124. The BG/FG extractor 180 decomposes the matrix as X=B+F based on a matrix decomposition objective, where X corresponds to the matrix, B corresponds to the extracted BG IB 182, and F corresponds to the extracted FG IB 184. In a particular aspect, the matrix decomposition objective includes minimizing ∥X−B∥ subject to the constraint that B is low rank, where ∥X−B∥ corresponds to L1 norm or L2 norm of the matrix inside. The BG/FG extractor 180 provides the extracted BG IB 182, the extracted FG IB 184, or both, to the image selector 190.

Alternatively, the BG/FG extractor 180 may, in response to determining that the control value 172 has the first value (e.g., 0), refrain from generating the extracted BG IB 182 and the extracted FG IB 184. For example, the BG/FG extractor 180 refrains from performing image decomposition on the IB 140 in response to determining that the control value 172 has the first value (e.g., 0). Selectively performing image decomposition for some of the IBs of the image frame 114 conserves computational resources, as compared to performing image decomposition of the entire image frame 114.

The image selector 190 may generate at least one of the BG IB 192 or the FG IB 194 based on the control value 172. For example, the image selector 190, in response to determining that the control value 172 has the first value (e.g., 0), selects the BG prediction error 162 as the FG IB 194, the predicted BG IB 152 as the BG IB 192, or both. The BG prediction error 162 includes a set of pixel values representing an image block. As another example, the image selector 190, in response to determining that the control value 172 has the second value (e.g., 1), selects the extracted BG IB 182 as the BG IB 192, the extracted FG IB 184 as the FG IB 194, or both. The image selector 190 adds the BG IB 192 to the first BG IBs 120 in the image buffer 106. The image selector 190 may add the FG IB 194 to the first FG IBs 130 in the image buffer 106. The image selector 190 provides at least one of the BG IB 192 or the FG IB 194 to the image analyzer 196.

The image analyzer 196 may perform an analysis (such as a security analysis) based on at least the FG IB 194 or the BG IB 192. For example, the image analyzer 196 may determine whether one or more characteristics of the FG IB 194, one or more characteristics of the BG IB 192, or a combination thereof, satisfy at least one alert criterion. To illustrate, the image analyzer 196 may perform object detection or object tracking based on at least the FG IB 194. In a particular aspect, the image analyzer 196 combines the FG IB 194 with one or more FG IBs corresponding to one or more other IBs of the image frame 114 to generate a combined FG image corresponding to the image frame 114. The image analyzer 196 may perform object detection or object tracking based on the combined FG image. In a particular aspect, the image analyzer 196 performs object tracking based on one or more FG IBs corresponding to image frames that are prior to or subsequent to the image frame 114 in the video stream 112. The image analyzer 196 may determine that one or more characteristics of the FG IB 194 (or the combined FG image) satisfy at least one alert criterion in response to determining that a detected object corresponding to the FG IB 194 matches at least one target object indicated in one or more target images. For example, in a traffic monitoring setting, the FG IB 194 is received from a traffic camera and the target objects correspond to images of license plates of interest to law enforcement. In a healthcare setting, the FG IB 194 may correspond to an angiogram of a patient and the target images may correspond to images indicative of disorders.

In a particular aspect, the image analyzer 196 may determine that one or more characteristics of the FG IB 194 satisfy at least one alert criterion in response to determining that a speed of a tracked object satisfies (e.g., is less than, equal to, or more than) a threshold. In a traffic monitoring setting, the FG IB 194 may be received from a traffic camera and the object tracking may indicate a speed of a detected vehicle that is greater than a speeding threshold.

The image analyzer 196 may, in response to determining that one or more characteristics of the FG IB 194, one or more characteristics of the BG IB 192, or a combination thereof, satisfy at least one alert criterion, send an alert message to a communication device, provide an alert message to the display 186, activate a lock, or a combination thereof. Comparing the FG IB 194 to the target images may be computationally more efficient than comparing the IB 140 to the target images when the FG IB 194 is smaller than the IB 140.

During an initialization stage, a count of previously-analyzed image frames of the video stream 112 is less than the initialization threshold 118. The prediction-based BG IB generator 104 detects the initialization stage in response to determining that image-blocks (e.g., the first BG IBs 120, the second BG IBs 122, the first FG IBs 130, the second FG IBs 132, the first IBs 124, the second IBs 126, or a combination thereof) stored by the image buffer 106 correspond to a subset of the image frames 110 and that a size of the subset fails to satisfy (e.g., is less than) the initialization threshold 118. The prediction-based BG IB generator 104, in response to detecting the initialization stage, generates the extracted BG IB 182, the extracted FG IB 184, or both, based on the IB 140, as described with reference to the BG/FG extractor 180 (e.g., using image decomposition). The prediction-based BG IB generator 104 detects a prediction stage in response to determining that the size of the subset satisfies (e.g., is greater than or equal to) the initialization threshold 118. The BG predictor 150 generates the predicted BG IB 152 in response to detecting the prediction stage. The image comparator 160 generates the BG prediction error 162 in response to detecting the prediction stage.

Because generating the predicted BG IB 152 may be computationally less expensive than image decomposition to generate the extracted BG IB 182 or the extracted FG IB 184, processing resources may be conserved by using the predicted BG IB 152 if the predicted BG IB 152 is relatively similar to the IB 140 and reserving image decomposition for the initialization stage or if the predicted BG IB 152 is not relatively similar to the IB 140. In addition, processing resources to perform image decomposition for an individual image-block (e.g., the IB 140) may be reduced as compared to decomposition for the entire image frame 114. Analyzing some or all of the image-blocks in parallel may also reduce latency for object detection, tracking, and recognition/surveillance monitoring applications.

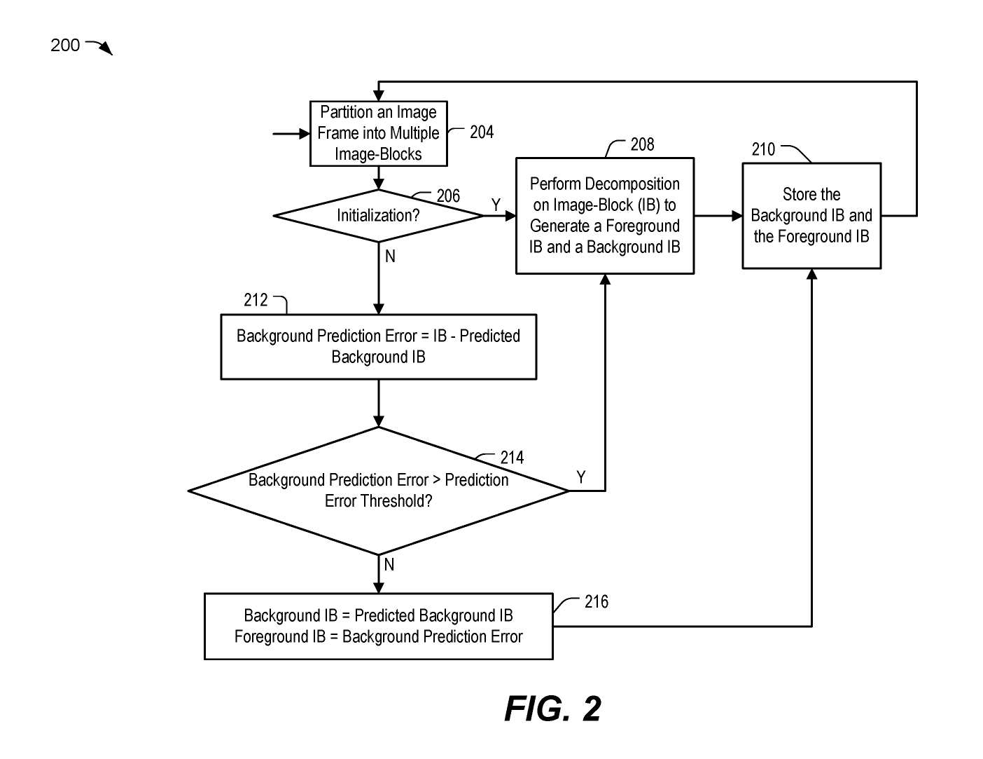

Referring to FIG. 2, a flow chart illustrating a particular method of operation of the device 102 is shown and generally designated 200. The method 200 may be performed by the BG predictor 150, the image comparator 160, the error comparator 170, the BG/FG extractor 180, the image selector 190, the prediction-based BG IB generator 104, the device 102 of FIG. 1, or a combination thereof.

The method 200 includes partitioning an image frame into multiple image-blocks, at 204. For example, the prediction-based BG IB generator 104 of FIG. 1 may partition the image frame 114 into a plurality of image-blocks, as described with reference to FIG. 1. The plurality of image-blocks may include IB 140, IB 142 of FIG. 1, one or more additional image-blocks, or a combination thereof. Each of the image-blocks may include multiple adjacent pixels of a portion of the image frame 114.

The method 200 also includes determining whether an initialization stage is detected, at 206. For example, the prediction-based BG IB generator 104 of FIG. 1 may determine whether an initialization stage is detected based on the initialization threshold 118, as described with reference to FIG. 1.

The method 200 further includes, in response to determining that the initialization stage is detected, at 206, performing decomposition on an image-block (IB) to generate a foreground IB and a background IB, at 208. For example, the prediction-based BG IB generator 104 of FIG. 1, in response to determining that an initialization stage is detected, performs image decomposition based on a next IB (e.g., the IB 140) of the image frame 114 to generate the extracted BG IB 182, the extracted FG IB 184, or both, as described with reference to FIG. 1. The prediction-based BG IB generator 104 may select the extracted BG IB 182 to be the BG IB 192, the extracted FG IB 184 to be the FG IB 194, or both.

The method 200 also includes storing the background IB and the foreground IB, at 210. For example, the prediction-based BG IB generator 104 of FIG. 1 may store the BG IB 192, the FG IB 194, or both, in the image buffer 106 of FIG. 1. The method 200 proceeds to 204. In FIG. 2, analysis of one IB of the image frame 114 followed by an analysis of a next image frame. Each of other IBs of the plurality of IBs of the image frame 114 may be analyzed in parallel. In a particular implementation, at least some of the plurality of IBs may be analyzed sequentially. For example, the method 200 may proceed from 210 to 206 in response to determining that a next IB of the image frame 114 is to be analyzed. The method 200 proceeds from 210 to 204 subsequent to analysis (e.g., parallel, partially parallel, or sequential) of all of the plurality of IBs.

The method 200 further includes, in response to determining that the initialization stage is not detected, at 206, determining a background prediction error based on a difference between the IB and a predicted background IB, at 212. For example, the image comparator 160 may, in response to determining that the initialization stage is not detected (e.g., a prediction stage is detected), determine the BG prediction error 162 based on a difference between the IB 140 and the predicted BG IB 152, as described with reference to FIG. 1.

The method 200 also includes determining whether the background prediction error is greater than the prediction error threshold, at 214. For example, the error comparator 170 of FIG. 1 may determine whether the BG prediction error 162 satisfies the prediction error threshold 116. The method 200 further includes, in response to determining that the BG prediction error 162 fails to satisfy (e.g., is greater than) the prediction error threshold 116, at 214, proceeding to 208.

The method 200 further includes, in response to determining that the BG prediction error 162 satisfies (e.g., is less than or equal to) the prediction error threshold 116, at 214, selecting the predicted background IB as the background IB and selecting the background prediction error as the foreground IB, at 216. For example, the image selector 190 of FIG. 1 may, in response to determining that a first value (e.g., 0) of the control value 172 indicates that the BG prediction error 162 satisfies the prediction error threshold 116, select the predicted BG IB 152 as the BG IB 192 and the BG prediction error 162 as the FG IB 194, as described with reference to FIG. 1. The method 200 proceeds to 210.

The method 200 thus enables selectively performing image decomposition for image extraction. For example, the predicted BG IB 152 may be generated as the BG IB 192 if the IB 140 is relatively similar to the predicted BG IB 152 and image decomposition may be reserved for initialization stage or if the IB 140 is not relatively similar to the predicted BG IB 152. Because image decomposition may be computationally more expensive than background prediction, selective performance of image decomposition may conserve resources (e.g., time and processing cycles) when image decomposition is not performed for at least some IBs of the image frame 114.

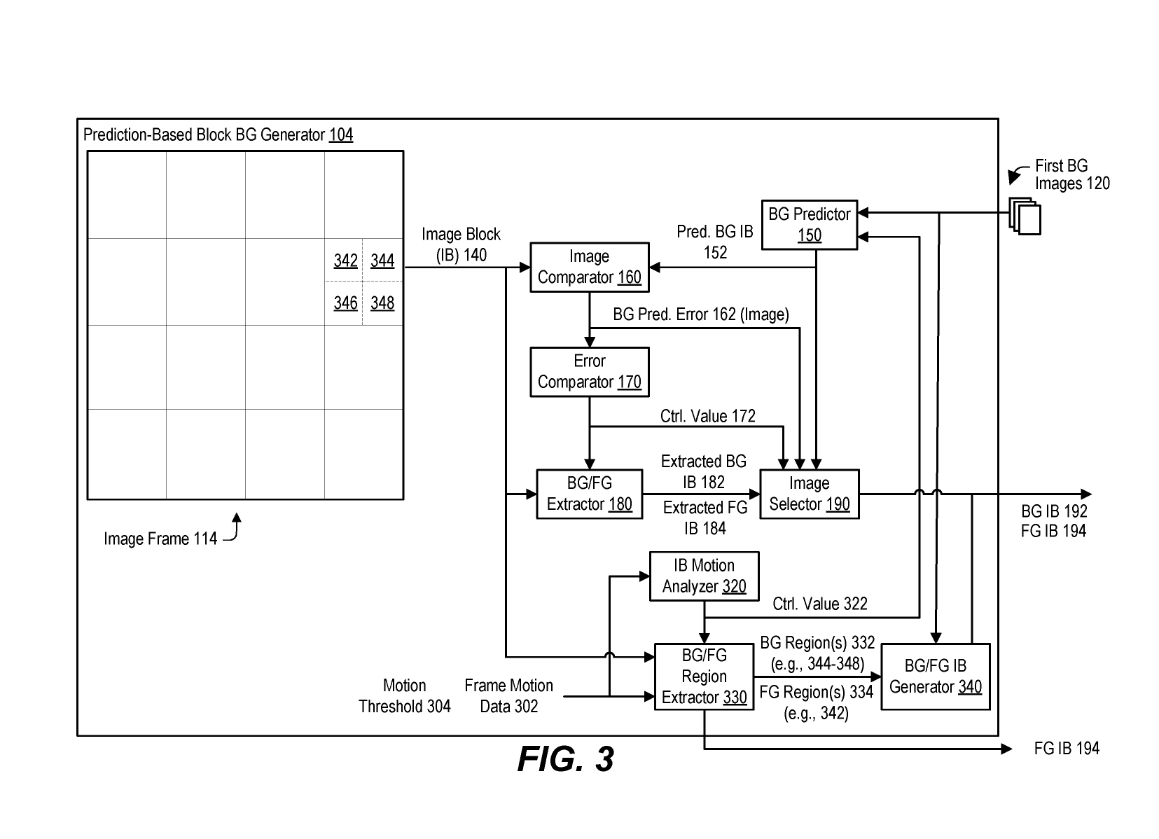

Referring to FIG. 3, an aspect of the prediction-based BG IB generator 104 is shown. As illustrated in FIG. 3, the prediction-based BG IB generator 104 may generate the BG IB 192, the FG IB 194, or both, based on motion data. The prediction-based BG IB generator 104 may include an IB motion analyzer 320 coupled, via a BG/FG region extractor 330, to a BG/FG IB generator 340. The IB motion analyzer 320 may be coupled to the BG predictor 150. While FIG. 1 illustrates a particular implementation of the prediction-based BG IB generator 104 that generates the BG IB 192, the FG IB 194, or both, independently of motion data, FIG. 3 illustrates another particular implementation of the prediction-based BG IB generator 104 that generates the BG IB 192, the FG IB 194, or both, based on motion data.

One or more image-blocks of the image frame 114 may include a plurality of regions. For example, the IB 140 may include a region 342, a region 344, a region 346, a region 348, or a combination thereof. Although, regions 342-348 are illustrated as rectangular, non-overlapping, and equal-sized, it should be understood that the prediction-based BG IB generator 104 may generate the regions 342-348 in another manner. For example, at least one of the regions 342-348 may be non-rectangular, at least two of the regions 342-348 may overlap each other, one of the regions 342-348 may have a first size that is distinct from another of the regions 342-348, or a combination thereof. It should be understood that the IB 140 including four regions is shown as an illustrative example. In other implementations, the IB 140 may include fewer than 4 regions or more than 4 regions.

The prediction-based BG IB generator 104 generates frame motion data 302 of the image frame 114. The frame motion data 302 representing motion detected in regions of the image frame 114 relative to corresponding regions of a first image frame of the image frames 110. The first image frame may be prior to the image frame 114 in the video stream 112. For example, the prediction-based BG IB generator 104 may generate motion vectors by performing a motion analysis of the image frame 114 based on a subset of the image frames 110. The subset of the image frames 110 may be prior to the image frame 114 in the video stream 112 and may include the first image frame. The prediction-based BG IB generator 104 may store the frame motion data 302 in the memory 103 of FIG. 1. For example, the analysis data 176 includes the frame motion data 302.

The IB motion analyzer 320 determines IB motion data corresponding to the IB 140 based on the frame motion data 302. For example, the frame motion data 302 indicates a first motion vector corresponding to the region 342, a second motion vector corresponding to the region 344, a third motion vector corresponding to the region 346, and a fourth motion vector corresponding to the region 348. The IB motion data may be based on a first magnitude of the first motion vector, a second magnitude of the second motion vector, a third magnitude of the third motion vector, a fourth magnitude of the fourth motion vector, or a combination thereof. For example, the IB motion data may correspond to a highest one of the first magnitude, the second magnitude, the third magnitude, the fourth magnitude, or a combination thereof. In another aspect, the IB motion data indicates a sum, a mean, or a median of the first magnitude, the second magnitude, the third magnitude, the fourth magnitude, or a combination thereof.

The IB motion analyzer 320 determines whether the IB motion data satisfies a motion threshold 304. The motion threshold 304 may correspond to a default value, a configuration setting, or both. The motion threshold 304 may be based on an input received from a user that indicates the default value, the configuration setting, or both. The motion threshold 304 may correspond to a particular motion value (e.g., a minimum motion value) that indicates that motion is detected. The analysis data 176 of FIG. 1 may include the motion threshold 304. The IB motion analyzer 320 assigns a first value (e.g., 0) to a control value 322 in response to determining that the IB motion data fails to satisfy (e.g., is less than) the motion threshold 304. The first value (e.g., 0) of the control value 322 may indicate that no or little motion is detected in the IB 140. Alternatively, the IB motion analyzer 320 assigns a second value (e.g., 1) to the control value 322 in response to determining that the IB motion data satisfies (e.g., is greater than or equal to) the motion threshold 304. The second value (e.g., 1) of the control value 322 may indicate that motion is detected in the IB 140. The IB motion analyzer 320 provides the control value 322 to the BG/FG region extractor 330, to the BG predictor 150, or both.

The control value 322 may activate one of the BG predictor 150 or the BG/FG region extractor 330. For example, BG predictor 150 generates the predicted BG IB 152, as described with reference to FIGS. 1-2, in response to determining that the control value 322 has the first value (e.g., 0). The predicted BG IB 152 may thus be generated when little or no motion is detected in the IB 140 relative to a corresponding IB in another image frame (e.g., a previous image frame) of the video stream 112. The BG predictor 150 may refrain from generating the predicted BG IB 152 in response to determining that the control value 322 has the second value (e.g., 1). The predicted BG IB 152 may thus not be generated when motion is detected in the IB 140 relative to the corresponding IB in the previous image frame of the video stream 112.

The BG/FG region extractor 330, in response to determining that the control value 322 has the second value (e.g., 1), determines whether region motion data of at least one of the regions 342-348 within the IB 140 fails to satisfy the motion threshold 304. Regions that are associated with region motion data that fails to satisfy the motion threshold 304 may correspond to BG regions of the IB 140, whereas the remaining regions may correspond to FG regions of the IB 140. The BG/FG region extractor 330 identifies one or more of the regions 344-348 as one or more BG region(s) 332 in response to determining that region motion data of one or more of the regions 344-348 fails to satisfy the motion threshold 304. For example, the BG/FG region extractor 330 identifies the region 344 as a BG region in response to determining that region motion data (e.g., the second magnitude of the second motion vector) of the region 344 fails to satisfy (e.g., is less than) the motion threshold 304. Similarly, the BG/FG region extractor 330 identifies the region 346 and the region 348 as BG regions in response to determining that region motion data of each of the region 346 and the region 348 fails to satisfy the motion threshold 304.

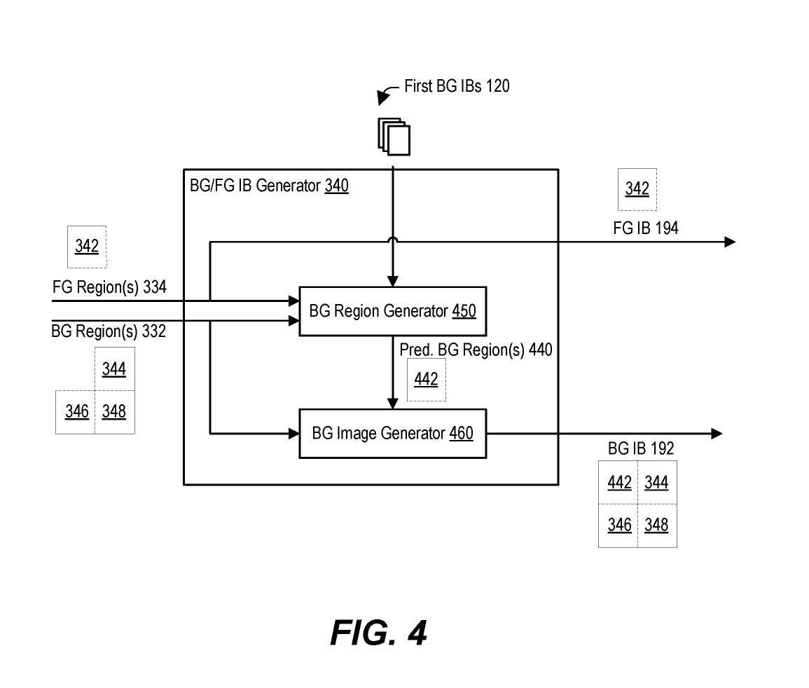

The BG/FG region extractor 330 may identify the remaining one or more regions of the IB 140 as one or more FG region(s) 334. For example, the BG/FG region extractor 330 identifies the region 342 as the one or more FG region(s) 334 in response to determining that the region 342 satisfies the motion threshold 304. The BG/FG region extractor 330 provides the BG region(s) 332, the FG region(s) 334, or a combination thereof, to the BG/FG IB generator 340. The BG/FG IB generator 340 generates the BG IB 192 based on the BG region(s) 332, the FG IB 194 based on the FG region(s) 334, or a combination thereof, as further described with reference to FIG. 4.

In a particular aspect, the BG/FG region extractor 330 designates the IB 140 as the FG IB 194 in response to determining that each of the regions 342-348 of the IB 140 satisfies the motion threshold 304. In this aspect, the BG/FG region extractor 330 may refrain from generating the BG IB 192.

The BG/FG extractor 180 may refrain from processing the IB 140 in response to determining that the control value 322 has the first value (e.g., 0). For example, the BG/FG extractor 180, in response to determining that the control value 322 has the first value (e.g., 0), refrains from generating the BG region(s) 332, the FG region(s) 334, and the FG IB 194. The BG/FG extractor 180 thus refrains from generating the BG region(s) 332, the FG region(s) 334, and the FG IB 194 when little or no motion is detected in the IB 140.

Prediction-based BG IB generator 104 may selectively perform image decomposition. The predicted BG IB 152 may be generated as the BG IB 192 if the IB 140 is relatively similar to the predicted BG IB 152. BG region(s) 332 may be used to generate the BG IB 192 if motion is detected in the IB 140 and little or no motion is detected in some of the regions of the IB 140. Identifying BG regions based on motion data may be computationally less expensive than image decomposition. The IB 140 may be generated as the FG IB 194 if motion is detected in all regions of the IB 140. Image decomposition may be reserved for an initialization stage, or if little or no motion is detected for IB 140 and the predicted BG IB 152 is not similar to the IB 140. Because image decomposition may be computationally more expensive than background prediction and background region identification based on motion data, selective performance of image decomposition may conserve resources (e.g., time and processing cycles) when image decomposition is not performed for at least some IBs of the image frame 114.

Referring to FIG. 4, an aspect of the BG/FG IB generator 340 is shown. The BG/FG IB generator 340 may include a BG region generator 450, a BG image generator 460, or both.

During operation, the BG region generator 450 may generate one or more predicted BG region(s) 440 corresponding to the FG region(s) 334 based on the first BG IBs 120, the BG region(s) 332, or a combination thereof. For example, the BG/FG IB generator 340 generates a region 442 of the predicted BG region(s) 440 corresponding to the region 342 based on the first BG IBs 120, the BG region(s) 332, or a combination thereof. To illustrate, the video stream 112 may capture a car moving down a street. The region 342 includes an image of the car (e.g., a portion of the car). A group of BG regions of the first BG IBs 120 correspond to the region 342. For example, each BG region of the group of BG regions has the same location (e.g., top-left corner of column 4 and row 2) as the region 342 in a corresponding image frame. The image of the car may be absent from the group of BG regions. For example, the group of BG regions may capture an image of a portion of the street before the car reaches that portion of the street. The BG region generator 450 generates the region 442 by performing a prediction analysis (e.g., linear regression analysis) on the group of BG regions. The image of the car may be absent from the region 442. For example, the region 442 corresponds to an image of the portion of the street that is behind (e.g., blocked by) the portion of the car in the region 342. The BG region generator 450 provides the predicted BG region(s) 440 (e.g., the region 442) to the BG image generator 460.

The BG image generator 460 may generate the BG IB 192 by combining the predicted BG region(s) 440 (e.g., the region 442) with the BG region(s) 332 (e.g., the regions 344-348). In a particular aspect, the BG image generator 460 generates the BG IB 192 by replacing one or more of the FG region(s) 334 (e.g., the region 342) in the IB 140 with a corresponding one or more of the predicted BG region(s) 440 (e.g., the region 442). The BG/FG IB generator 340 may designate the FG region(s) 334 (e.g., the region 342) as the FG IB 194.

In a particular aspect, generating the BG IB 192 based on the predicted BG region(s) 440 enables detection of an abandoned object as a foreground object by the image analyzer 196. For example, the image frame 114 captures an object that has moved into view of the video camera(s) 108 and has stopped moving. Because the BG IB 192 is generated based on the predicted BG region(s) 440, regions of subsequent image frames that capture portions of the object continue to be identified as foreground regions. In a particular aspect, the image analyzer 196 determines that characteristics of the FG IB 194 satisfy at least one alert criterion (e.g., an abandoned object is detected) in response to determining that the video stream 112 includes the same foreground object in more than a threshold number of image frames of the video stream 112.

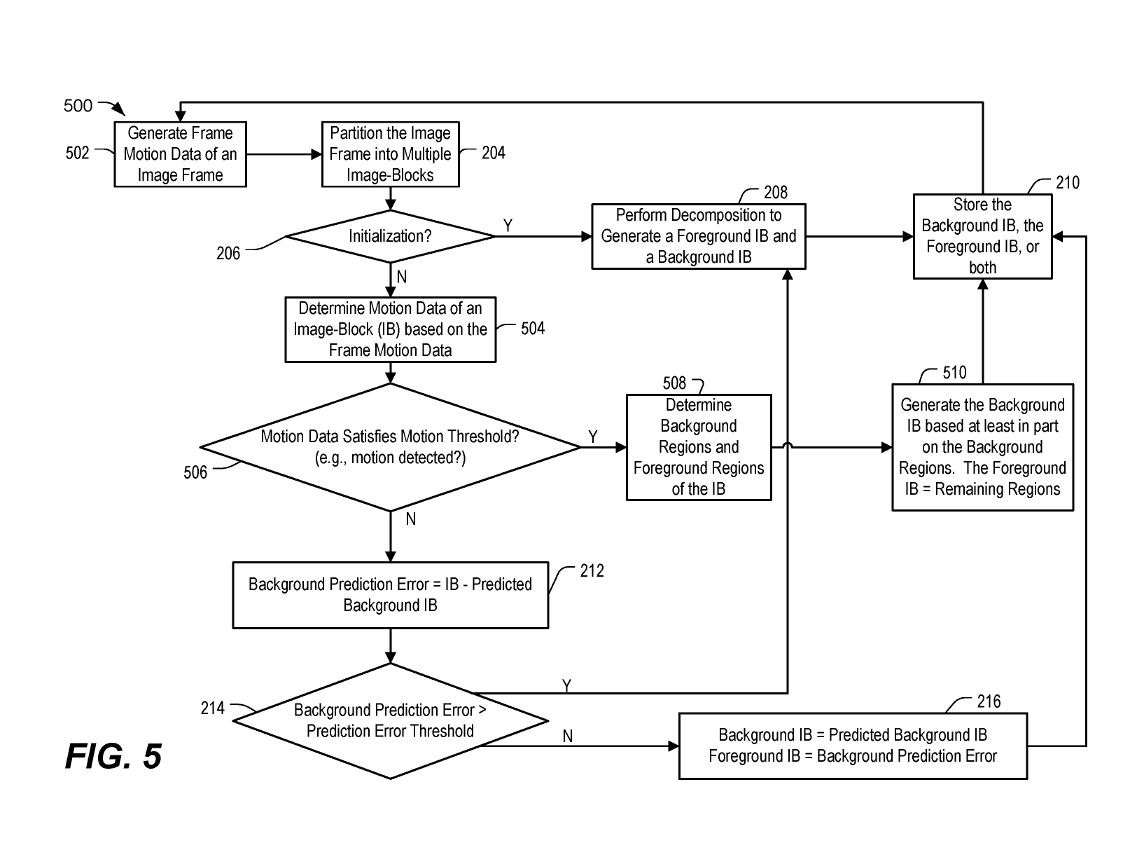

Referring to FIG. 5, a flow chart illustrating a particular method of operation of the device 102 is shown and generally designated 500. The method 500 may be performed by the BG predictor 150, the image comparator 160, the error comparator 170, the BG/FG extractor 180, the image selector 190, the prediction-based BG IB generator 104, the device 102 of FIG. 1, the IB motion analyzer 320, the BG/FG region extractor 330, the BG/FG IB generator 340 of FIG. 3, the BG region generator 450, the BG image generator 460 of FIG. 4, or a combination thereof.

The method 500 includes generating frame motion data of an image frame, at 502. The prediction-based BG IB generator 104 may generate the frame motion data 302 of the image frame 114, as described with reference to FIG. 3. The method 500 proceeds to 204.

The method 500 also includes, in response to determining that an initialization stage is not detected, at 206, determining motion data of an image-block based on the frame motion data, at 504. For example, the IB motion analyzer 320 of FIG. 3 may determine IB motion data of the IB 140 based on the frame motion data 302, as described with reference to FIG. 3.

The method 500 further includes determining whether the motion data satisfies a motion threshold, at 506. For example, the IB motion analyzer 320 of FIG. 3 may determine whether the IB motion data satisfies the motion threshold 304, as described with reference to FIG. 3. The method 500 proceeds to 212, 214, 208, and 210 or 212, 214, 216, and 210, which proceed as described with respect to FIG. 2, in response to determining that the motion data fails to satisfy the motion threshold, at 506

The method 500 also includes, in response to determining that the motion data satisfies the motion threshold, at 506, determining background regions and foreground regions of the image-block, at 508. For example, the BG/FG region extractor 330 of FIG. 3 may, in response to determining that the second value (e.g., 1) of the control value 322 indicates that the IB motion data satisfies the motion threshold 304, determine the BG region(s) 332 and the FG region(s) 334 of the IB 140, as described with reference to FIG. 3.

The method 500 further includes generating the background image-block based at least in part on the background regions and generating the foreground image-block based on the remaining regions of the image-block, at 510. For example, the BG/FG IB generator 340 may generate the BG IB 192 based at least in part on the BG region(s) 332 and may generate the FG IB 194 based on the remaining regions (e.g., the FG region(s) 334), as described with reference to FIG. 4.

The method 500 enables selectively performance of image decomposition. Image decomposition (at 208) may be reserved for an initialization stage (e.g., an initialization stage is detected, at 206), or if little or no motion is detected for IB 140 and the predicted BG IB 152 is not similar to the IB 140 (e.g., the background prediction error is greater than the prediction error threshold, at 214). Because image decomposition may be computationally more expensive than background prediction, selective performance of image decomposition may conserve resources (e.g., time and processing cycles) when image decomposition is not performed for at least some IBs of the image frame 114.

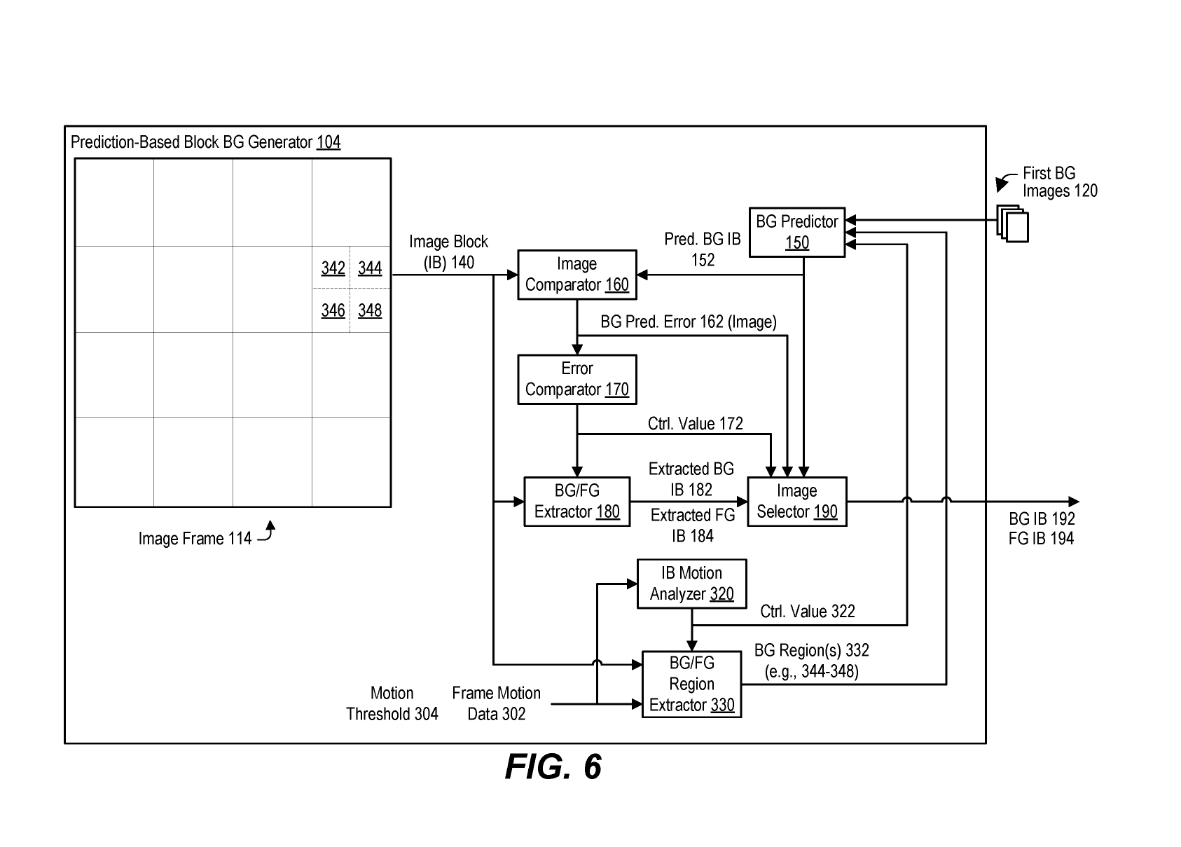

Referring to FIG. 6, an aspect of the prediction-based BG IB generator 104 is shown. As illustrated in FIG. 6, the prediction-based BG IB generator 104 may generate the BG IB 192 based on motion data or independently of motion data. The prediction-based BG IB generator 104 may include the BG/FG region extractor 330 coupled to the BG predictor 150. While FIG. 1 illustrates a particular implementation of the prediction-based BG IB generator 104 that generates the BG IB 192, the FG IB 194, or both, independently of motion data, and FIG. 3 illustrates another particular implementation of the prediction-based BG IB generator 104 that generates the BG IB 192, the FG IB 194, or both, based on motion data, FIG. 6 illustrates a particular implementation of the prediction-based BG IB generator 104 that generates the BG IB 192, the FG IB 194, or both, selectively based on motion data.

The IB motion analyzer 320 determines whether the IB motion data satisfies the motion threshold 304, as described with reference to FIG. 3. The IB motion analyzer 320 assigns a first value (e.g., 0) to the control value 322 in response to determining that the IB motion data fails to satisfy (e.g., is less than) the motion threshold 304. Alternatively, the IB motion analyzer 320 assigns a second value (e.g., 1) to the control value 322 in response to determining that the IB motion data satisfies (e.g., is greater than or equal to) the motion threshold 304. The IB motion analyzer 320 provides the control value 322 to the BG/FG region extractor 330, to the BG predictor 150, or both.

The control value 322 may activate the BG/FG region extractor 330. For example, the BG/FG region extractor 330, in response to determining that the control value 322 has the second value (e.g., 1), identifies one or more of the regions 342-348 as the BG region(s) 332 in response to determining that region motion data of one or more of the regions 342-348 fails to satisfy the motion threshold 304, as described with reference to FIG. 3. The BG/FG region extractor 330 provides the BG region(s) 332 to the BG predictor 150. Alternatively, the BG/FG extractor 180 may refrain from processing the IB 140 in response to determining that the control value 322 has the first value (e.g., 0). For example, the BG/FG extractor 180, in response to determining that the control value 322 has the first value (e.g., 0), refrains from generating the BG region(s) 332. The BG/FG extractor 180 thus refrains from generating the BG region(s) 332 when little or no motion is detected in the IB 140.

The BG predictor 150 may generate the predicted BG IB 152 based on the control value 322. For example, the BG predictor 150 may, in response to determining that the control value 322 has the first value (e.g., 0), generate the predicted BG IB 152 based on the first BG images 120, as described with reference to FIGS. 1-2. As another example, the BG predictor 150 may, in response to determining that the control value 322 has the second value (e.g., 1), generate the predicted BG IB 152 based on the BG region(s) 332, the first BG images 120, or a combination thereof. To illustrate, the BG predictor 150 may, in response to determining that the control value 322 has the second value (e.g., 1), generate the predicted BG region(s) 440 based on the first BG images 120, as described with reference to FIG. 4. The BG predictor 150 may generate the predicted BG IB 152 based on the BG region(s) 332 and the predicted BG region(s) 440. For example, the predicted BG IB 152 may include the BG region(s) 332 and the predicted BG region(s) 440.

A portion (e.g., the predicted BG region(s) 440) of the predicted BG IB 152 may thus be based on performing a prediction analysis, whereas a remaining portion (e.g., the BG region(s) 332) of the predicted BG IB 152 may be extracted from the IB 140 based on motion data. Identifying BG regions based on motion data may be computationally less expensive than image prediction. Image prediction may be reserved for portions of the predicted BG IB 152 in which motion is detected. Because image prediction may be computationally more expensive than background region identification based on motion data, selective performance of image prediction may conserve resources (e.g., time and processing cycles) when image prediction is not performed for at least some portions of the predicted BG IB 152.

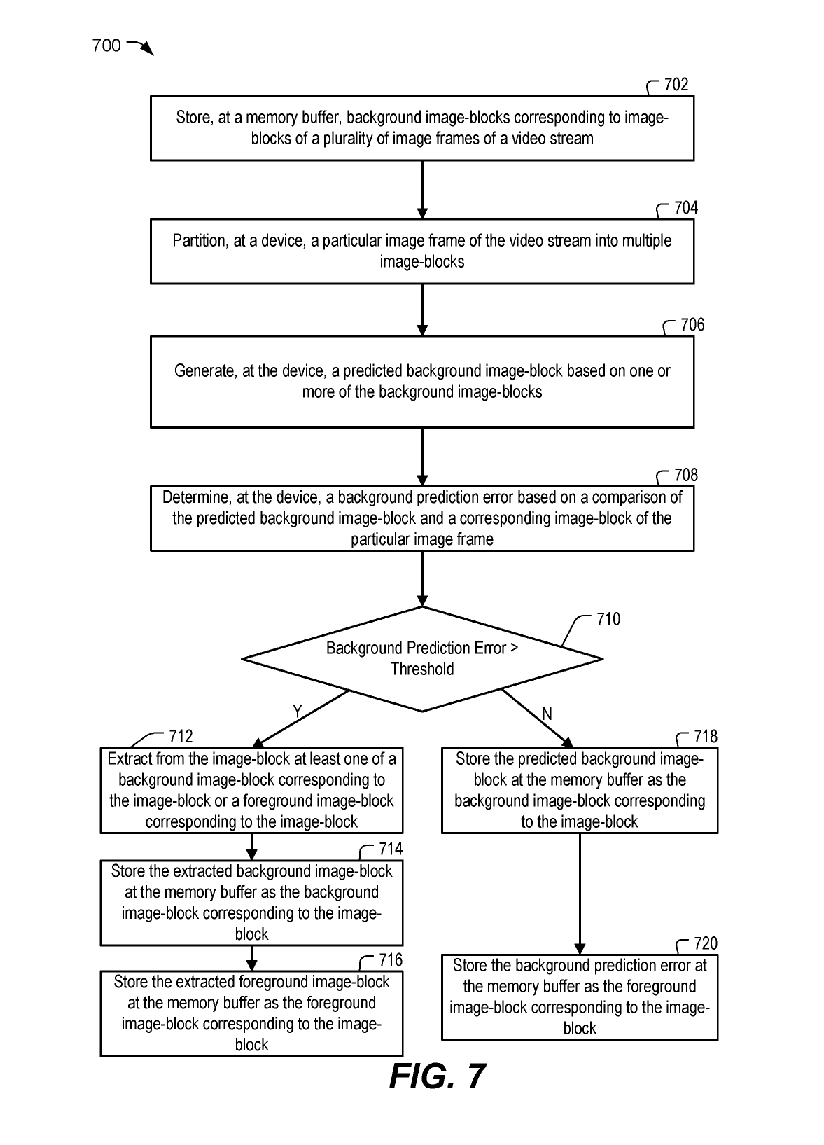

Referring to FIG. 7, a flow chart illustrating a particular method of operation of the device 102 is shown and generally designated 700. The method 700 may be performed by the BG predictor 150, the image comparator 160, the error comparator 170, the BG/FG extractor 180, the image selector 190, the prediction-based BG IB generator 104, the device 102 of FIG. 1, the IB motion analyzer 320, the BG/FG region extractor 330, the BG/FG IB generator 340 of FIG. 3, the BG region generator 450, the BG image generator 460 of FIG. 4, or a combination thereof.

The method 700 includes storing, at a memory buffer, background IBs corresponding to image-blocks of a plurality of image frames of a video stream, at 702. For example, the prediction-based BG IB generator 104 of FIG. 1 may store, at the image buffer 106, the first BG IBs 120 corresponding to the first IBs 124 and second BG IBs 122 corresponding to the second IBs 126 of a subset of the image frames 110 of the video stream 112, as described with reference to FIG. 1.

The method 700 also includes partitioning, at a device, a particular image frame of the video stream into multiple image-blocks, at 704. For example, the prediction-based BG IB generator 104 of FIG. 1 may partition the image frame 114 of the video stream 112 into a plurality of IBs, as described with reference to FIG. 1.

The method 700 further includes generating, at the device, a predicted background IB based on one or more of the background image-blocks, at 706. For example, the BG predictor 150 of FIG. 1 may generate the predicted BG IB 152 based on the first BG IBs 120, as described with reference to FIG. 1.

The method 700 also includes determining, at the device, a background prediction error based on a comparison of the predicted background IB and a corresponding image-block of the particular image frame, at 708. For example, the image comparator 160 of FIG. 1 may determine the BG prediction error 162 based on a comparison of the predicted BG IB 152 and the IB 140, as described with reference to FIG. 1.

The method 700 further includes determining whether the background prediction error is greater than a threshold, at 710. For example, the error comparator 170 of FIG. 1 may determine whether the BG prediction error 162 is greater than the prediction error threshold 116, as described with reference to FIG. 1.

The method 700 also includes, in response to determining that the background prediction error is greater than the threshold, at 710, extracting from the image-block at least one of a background IB corresponding to the image-block or a foreground image-block corresponding to the image-block, at 712. For example, the BG/FG extractor 180 may, in response to determining that the second value (e.g., 1) of the control value 172 indicates that the BG prediction error is greater than the prediction error threshold 116, perform image decomposition to extract from the IB 140 at least one of the extracted BG IB 182 or the extracted FG IB 184, as described with reference to FIG. 1.

The method 700 further includes storing the extracted background IB at the memory buffer as the background IB corresponding to the image-block, at 714. For example, the image selector 190 of FIG. 1 may store the extracted BG IB 182 at the image buffer 106 as the BG IB 192 corresponding to the IB 140, as described with reference to FIG. 1.

The method 700 also includes storing the extracted foreground image-block at the memory buffer as the foreground image-block corresponding to the image-block, at 716. For example, the image selector 190 of FIG. 1 may store the extracted FG IB 184 at the image buffer 106 as the FG IB 194 corresponding to the IB 140, as described with reference to FIG. 1.

The method 700 further includes, in response to determining that the background prediction error is less than or equal to the threshold, at 710, storing the predicted background IB at the memory buffer as the background IB corresponding to the image-block, at 718. For example, the image selector 190 of FIG. 1 may, in response to determining that the first value (e.g., 0) of the control value 172 indicates that the BG prediction error 162 is less than or equal to the prediction error threshold 116, store the predicted BG IB 152 at the image buffer 106 as the BG IB 192 corresponding to the IB 140, as described with reference to FIG. 1.

The method 700 also includes storing the background prediction error at the memory buffer as the foreground image-block corresponding to the image-block, at 720. For example, the image selector 190 of FIG. 1 may store the BG prediction error 162 at the image buffer 106 as the FG IB 194 corresponding to the IB 140, as described with reference to FIG. 1.

The method 700 enables selectively performance of image decomposition. Image decomposition may be reserved for an initialization stage, or if the predicted BG IB 152 is not similar to the IB 140. For example, if motion is detected in the IB 140, the BG IB 192 may be generated by using motion data to identify background regions of the IB 140, as described with reference to FIGS. 3-4. If little or no motion is detected in the IB 140 and the predicted BG IB 152 is similar to the IB 140, the predicted BG IB 152 may be designated as the BG IB 192, as described with reference to FIG. 3. During an initialization stage, or if little or no motion is detected in the IB 140 and the predicted BG IB 152 is similar to the IB 140, image decomposition may be performed to generate the extracted BG IB 182 and the extracted BG IB 182 may be designated as the BG IB 192, as described with reference to FIG. 3. Because image decomposition may be computationally more expensive than background prediction, selective performance of image decomposition may conserve resources (e.g., time and processing cycles) when image decomposition is not performed for at least some IBs of the image frame 114. The device 102 may process the IBs of the image frame 114 independently of other IBs of the image frame 114. For example, BG IBs corresponding to a first subset of IBs of the image frame 114 may be generated using image decomposition. Predicted BG IBs may be designated as BG IBs corresponding to a second subset of the IBs of the image frame 114. BG IBs corresponding to a third subset of the IBs of the image frame 114 may include background regions identified using motion data.

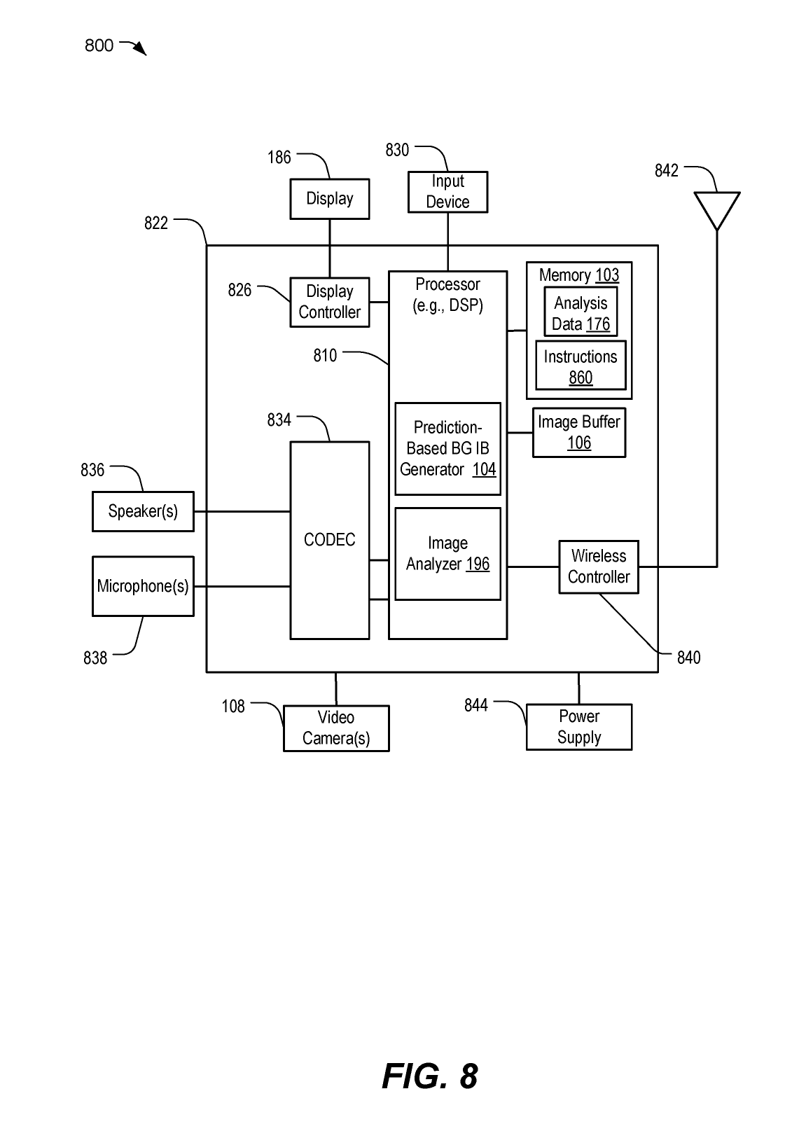

Referring to FIG. 8, a block diagram of a particular illustrative example of a device (e.g., a wireless communication device) is depicted and generally designated 800. In various aspects, the device 800 may have fewer or more components than illustrated in FIG. 8. In an illustrative aspect, the device 800 may correspond to the device 102 of FIG. 1. In an illustrative aspect, the device 800 may perform one or more operations described with reference to systems and methods of FIGS. 1-7.

In a particular aspect, the device 800 includes a processor 810. The processor 810 may include a central processing unit (CPU), one or more digital signal processor (DSPs), or a combination thereof. The processor 810 may include, or be coupled to, the prediction-based BG IB generator 104, the image analyzer 196, or both. The device 800 may include the memory 103, a coder-decoder (CODEC) 834, and the image buffer 106. The device 800 may include a wireless controller 840 coupled to an antenna 842. The device 800 may include the display 186 coupled to a display controller 826. One or more speakers 836 may be coupled to the CODEC 834. One or more microphones 838 may be coupled to the CODEC 834.

The memory 103 may include instructions 860 executable by the processor 810, the prediction-based BG IB generator 104, the image analyzer 196, the CODEC 834, another processing unit of the device 800, or a combination thereof, to perform one or more operations described with reference to FIGS. 1-7. The memory 103 may store the analysis data 176.

One or more components of the device 800 may be implemented via dedicated hardware (e.g., circuitry), by a processor executing instructions to perform one or more tasks, or a combination thereof. As an example, the memory 103, the image buffer 106, or one or more components of the processor 810, the prediction-based BG IB generator 104, the image analyzer 196, the CODEC 834, or a combination thereof, may be a memory device (e.g., a computer-readable storage device), such as a random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). The memory device may include (e.g., store) instructions (e.g., the instructions 860) that, when executed by a computer (e.g., a processor in the CODEC 834, the processor 810, the prediction-based BG IB generator 104, the image analyzer 196, or a combination thereof), may cause the computer to perform one or more operations described with reference to FIGS. 1-7. As an example, the memory 103 or the one or more components of the processor 810, the CODEC 834, the prediction-based BG IB generator 104, the image analyzer 196, or a combination thereof, may be a non-transitory computer-readable medium that includes instructions (e.g., the instructions 860) that, when executed by a computer (e.g., a processor in the CODEC 834, the prediction-based BG IB generator 104, the image analyzer 196, the processor 810, or a combination thereof), cause the computer perform one or more operations described with reference to FIGS. 1-7.

In a particular aspect, the device 800 may be included in a system-in-package or system-on-chip device (e.g., a mobile station modem (MSM)) 822. In a particular aspect, the processor 810, the prediction-based BG IB generator 104, the image analyzer 196, the display controller 826, the memory 103, the CODEC 834, and the wireless controller 840 are included in a system-in-package or the system-on-chip device 822. In a particular aspect, an input device 830 (e.g., a touchscreen, a keypad, or both), a power supply 844, and the video camera(s) 108 are coupled to the system-on-chip device 822. Moreover, in a particular aspect, as illustrated in FIG. 8, the display 186, the input device 830, the speakers 836, the microphones 838, the antenna 842, the power supply 844, and the video camera(s) 108 are external to the system-on-chip device 822. However, each of the display 186, the input device 830, the speakers 836, the microphones 838, the antenna 842, the power supply 844, and the video camera(s) 108 can be coupled to a component of the system-on-chip device 822, such as an interface or a controller.

In a particular aspect, one or more components of the systems described with reference to FIGS. 1-7 and the device 800 may be integrated into (e.g., the device 800 may include) a security camera, a manned aerial vehicle, an unmanned aerial vehicle, a wireless telephone, a mobile communication device, a mobile device, a mobile phone, a smart phone, a cellular phone, a laptop computer, a desktop computer, a computer, a tablet computer, a set top box, a personal digital assistant (PDA), a display device, a television, a game console, a music player, a radio, a video player, an entertainment unit, a communication device, a fixed location data unit, a personal media player, a digital video player, a digital video disc (DVD) player, a tuner, a camera, a navigation device, a decoder system, an encoder system, another type of device, or any combination thereof.

It should be noted that various functions performed by the one or more components of the systems described with reference to FIGS. 1-7 and the device 800 are described as being performed by certain components or modules. This division of components and modules is for illustration. In an alternate aspect, a function performed by a particular component or module may be divided amongst multiple components or modules. Moreover, in an alternate aspect, two or more components or modules described with reference to FIGS. 1-8 may be integrated into a single component or module. Each component or module described with reference to FIGS. 1-8 may be implemented using hardware (e.g., a field-programmable gate array (FPGA) device, an application-specific integrated circuit (ASIC), a processor, a DSP, a controller, etc.), software (e.g., instructions executable by a processor), or any combination thereof.

In conjunction with the described aspects, an apparatus includes means for storing background IBs corresponding to image-blocks of a plurality of image frames of a video stream. For example, the means for storing may include the image buffer 106, the device 102 of FIG. 1, the device 800, one or more devices configured to store background IBs (e.g., a computer-readable storage device), or a combination thereof.

The apparatus also includes means for extracting from an image-block of a particular image frame of the video stream at least one of a background IB corresponding to the image-block or a foreground image-block corresponding to the image-block based on determining that a background prediction error is greater than a threshold. For example, the means for extracting may include the prediction-based BG IB generator 104, the device 102 of FIG. 1, the processor 810, the device 800, one or more devices configured to extract from the image-block at least one of the background IB or the foreground image-block (e.g., a processor executing instructions that are stored at a computer-readable storage device), or a combination thereof. The BG prediction error 162 may be based on a comparison of the IB 140 and the predicted BG IB 152. The predicted BG IB 152 may be based on the first BG IBs 120 corresponding to the first IBs 124.

The apparatus may include means for partitioning a particular image frame of the video stream into multiple image-blocks. For example, the means for partitioning may include the prediction-based BG IB generator 104, the device 102 of FIG. 1, the processor 810, the device 800, one or more devices configured to partition a particular image frame of the video stream into multiple image-blocks (e.g., a processor executing instructions that are stored at a computer-readable storage device), or a combination thereof. The multiple image-blocks may include the IB 140.

The apparatus may include means for generating a predicted background image-block based on one or more of the background image-blocks. For example, the means for generating the predicted background image-block may include the BG predictor 150, the prediction-based BG IB generator 104, the device 102 of FIG. 1, the processor 810, the device 800, one or more devices configured to generate a predicted background image-block based on one or more of the background image-blocks (e.g., a processor executing instructions that are stored at a computer-readable storage device), or a combination thereof.

The apparatus may include means for determining a background prediction error based on a comparison of the predicted background image-block and a corresponding image-block of the particular image frame. For example, the means for determining the background prediction error may include the image comparator 160, the prediction-based BG IB generator 104, the device 102 of FIG. 1, the processor 810, the device 800, one or more devices configured to determine a background prediction error based on a comparison of the predicted background image-block and a corresponding image-block of the particular image frame (e.g., a processor executing instructions that are stored at a computer-readable storage device), or a combination thereof.

The apparatus may include means for storing the predicted background image-block as the background image-block corresponding to the image-block based on determining that the background prediction error is less than or equal to the threshold. For example, the means for storing may include the image buffer 106, the image selector 190, the prediction-based BG IB generator 104, the device 102 of FIG. 1, the processor 810, the device 800, one or more devices configured to store the predicted background image-block as the background image-block (e.g., a computer-readable storage device), or a combination thereof.

The apparatus may include means for storing the background prediction error as the foreground image-block corresponding to the image-block based on determining that the background prediction error is less than or equal to the threshold. For example, the means for storing may include the image buffer 106, the image selector 190, the prediction-based BG IB generator 104, the device 102 of FIG. 1, the processor 810, the device 800, one or more devices configured to store the background prediction error as the foreground image-block (e.g., a computer-readable storage device), or a combination thereof.

The apparatus may include means for generating frame motion data representing motion detected in regions of the particular image frame relative to corresponding regions of another image frame of the video stream. For example, the means for generating frame motion data may include the prediction-based BG IB generator 104, the device 102 of FIG. 1, the processor 810, the device 800, one or more devices configured to generate the frame motion data (e.g., a computer-readable storage device), or a combination thereof. The image-block (e.g., IB 140 of FIG. 1) may include a subset of the regions of the particular image frame (e.g. the image frame 114 of FIG. 1). The image-block motion data may be based on the frame motion data (e.g., the frame motion data 302 of FIG. 3).

The apparatus may include means for determining image-block motion data corresponding to the image-block based on the frame motion data, the image-block including a subset of the regions of the particular image frame. For example, the means for determining image-block motion data may include the IB motion analyzer 320, the prediction-based BG IB generator 104, the device 102 of FIG. 1, the processor 810, the device 800, one or more devices configured to determine the image-block motion data (e.g., a computer-readable storage device), or a combination thereof.

The apparatus may include means for generating the predicted background image-block based on determining that the image-block motion data fails to satisfy a motion threshold. The means for generating the predicted background image-block may include the BG predictor 150, the prediction-based BG IB generator 104, the device 102 of FIG. 1, the processor 810, the device 800, one or more devices configured to generate the predicted background image-block (e.g., a processor executing instructions that are stored at a computer-readable storage device), or a combination thereof.

The apparatus may include means for storing at least one of the background image-block corresponding to the image-block or the foreground image-block corresponding to the image-block. For example, the means for storing may include the image buffer 106, the image selector 190, the prediction-based BG IB generator 104, the device 102 of FIG. 1, the processor 810, the device 800, one or more devices configured to store at least one of the background image-block corresponding to the image-block or the foreground image-block corresponding to the image-block (e.g., a computer-readable storage device), or a combination thereof.

The apparatus may include means for determining background regions of the image-block corresponding to one or more regions within the image-block and foreground regions of the image-block corresponding to the remaining regions of the image-block based on determining that the image-block motion data satisfies a motion threshold and that region motion data corresponding to the one or more regions fails to satisfy the motion threshold. For example, the means for determining the background regions and the foreground regions may include the prediction-based BG IB generator 104, the device 102 of FIG. 1, the IB motion analyzer 320, the BG/FG region extractor 330 of FIG. 3, the processor 810, the device 800, one or more devices configured to determine the background regions and the foreground regions (e.g., a processor executing instructions that are stored at a computer-readable storage device), or a combination thereof. The foreground image-block (e.g., the FG IB 194 of FIG. 1) may include the foreground regions (e.g., the FG region(s) 334) of the image-block (e.g., the IB 140).

The apparatus may include means for generating the background image-block based on the background regions of the image-block and the one or more of the background image-blocks. For example, the means for generating the background image-block may include the prediction-based BG IB generator 104, the device 102 of FIG. 1, the BG/FG IB generator 340 of FIG. 3, the processor 810, the device 800, one or more devices configured to determine the background regions and the foreground regions (e.g., a processor executing instructions that are stored at a computer-readable storage device), or a combination thereof. The foreground image-block (e.g., the FG IB 194) may include the foreground regions (e.g., the FG region(s) 334) of the image-block (e.g., IB 140).

The apparatus may include means for storing the image-block as the foreground image-block corresponding to the image-block based on determining that the image-block motion data satisfies a motion threshold and that region motion data corresponding to each region within the image-block satisfies the motion threshold. For example, the means for storing may include the image buffer 106, the prediction-based BG IB generator 104, the device 102 of FIG. 1, the BG/FG region extractor 330 of FIG. 3, the processor 810, the device 800, one or more devices configured to store the image-block as the foreground image-block (e.g., a computer-readable storage device), or a combination thereof.

The apparatus may include means for generating the video stream. For example, the means for generating the video stream may include the video camera(s) 108, the device 102 of FIG. 1, the processor 810, the device 800, one or more devices configured to generate the video stream (e.g., one or more cameras, one or more security cameras, or a computer-readable storage device), or a combination thereof.

The apparatus may include means for performing a security analysis based on the at least one of the foreground image-block or the background image-block. For example, the means for performing the security analysis may include the image analyzer 196, the device 102 of FIG. 1, the processor 810, the device 800, one or more devices configured to perform a security analysis (e.g., a processor executing instructions that are stored at a computer-readable storage device), or a combination thereof.

The apparatus may include means for generating an alert message based on determining, during the security analysis, that one or more characteristics of the foreground image-block satisfy at least one alert criterion. For example, the means for generating the alert message may include the image analyzer 196, the device 102 of FIG. 1, the processor 810, the device 800, one or more devices configured to perform a security analysis (e.g., a processor executing instructions that are stored at a computer-readable storage device), or a combination thereof.

The apparatus may include means for sending at least the foreground image-block to a second device in response to determining that one or more characteristics of the foreground image-block satisfy at least one criterion. For example, the means for sending may include the image analyzer 196, the device 102 of FIG. 1, the processor 810, the device 800, the wireless controller 840, the antenna 842, one or more devices configured to send at least the foreground image-block (e.g., a transmitter or a processor executing instructions that are stored at a computer-readable storage device), or a combination thereof.

The apparatus may include means for extracting at least one of the background image-block or the foreground image-block from the image-block using image decomposition techniques. For example, the means for extracting may include the BG/FG extractor 180, the prediction-based BG IB generator 104, the device 102 of FIG. 1, the processor 810, the device 800, one or more devices configured to extract at least one of the background image-block or the foreground image-block (e.g., a processor executing instructions that are stored at a computer-readable storage device), or a combination thereof.

The apparatus may include means for generating a second predicted background image-block independently of generating the predicted background image-block. For example, the means for generating the second predicted background image-block may include the prediction-based BG IB generator 104, the device 102 of FIG. 1, the processor 810, the device 800, one or more devices configured to generate the second predicted background image-block (e.g., a processor executing instructions that are stored at a computer-readable storage device), or a combination thereof.

The apparatus may include means for extracting from a corresponding second image-block of the particular image frame, based on the second predicted background image-block, at least one of a second background image-block corresponding to the second image-block or a second foreground image-block corresponding to the second image-block. For example, the means for extracting may include the BG/FG extractor 180, the prediction-based BG IB generator 104, the device 102 of FIG. 1, the processor 810, the device 800, one or more devices configured to extract at least one of the second background image-block or the second foreground image-block (e.g., a processor executing instructions that are stored at a computer-readable storage device), or a combination thereof.

Those of skill would further appreciate that the various illustrative logical blocks, configurations, modules, circuits, and algorithm steps described in connection with the aspects disclosed herein may be implemented as electronic hardware, computer software executed by a processing device such as a hardware processor, or combinations of both. Various illustrative components, blocks, configurations, modules, circuits, and steps have been described above generally in terms of their functionality. Whether such functionality is implemented as hardware or executable software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the aspects disclosed herein may be embodied directly in hardware, in a software module executed by a processor, or in a combination of the two. A software module may reside in a memory device, such as random access memory (RAM), magnetoresistive random access memory (MRAM), spin-torque transfer MRAM (STT-MRAM), flash memory, read-only memory (ROM), programmable read-only memory (PROM), erasable programmable read-only memory (EPROM), electrically erasable programmable read-only memory (EEPROM), registers, hard disk, a removable disk, or a compact disc read-only memory (CD-ROM). An exemplary memory device is coupled to the processor such that the processor can read information from, and write information to, the memory device. In the alternative, the memory device may be integral to the processor. The processor and the storage medium may reside in an application-specific integrated circuit (ASIC). The ASIC may reside in a computing device or a user terminal. In the alternative, the processor and the storage medium may reside as discrete components in a computing device or a user terminal.

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A device comprising:
a memory buffer configured to store background image-blocks corresponding to image-blocks of a plurality of image frames of a video stream; and
a processor configured to:
partition a particular image frame of the video stream into multiple image-blocks;
generate a predicted background image-block based on one or more of the background image-blocks;
determine a background prediction error based on a comparison of the predicted background image-block and a corresponding image-block of the particular image frame; and
based on determining that the background prediction error is greater than a threshold, extract from the image-block at least one of a background image-block corresponding to the image-block or a foreground image-block corresponding to the image-block.

2. The device of claim 1, wherein the processor is further configured, based on determining that the background prediction error is less than or equal to the threshold, to store the predicted background image-block at the memory buffer as the background image-block corresponding to the image-block.

3. The device of claim 1, wherein the processor is further configured, based on determining that the background prediction error is less than or equal to the threshold, to store the background prediction error at the memory buffer as the foreground image-block corresponding to the image-block.

4. The device of claim 1, wherein the processor is configured to:
generate frame motion data representing motion detected in regions of the particular image frame relative to corresponding regions of another image frame of the video stream; and
determine image-block motion data corresponding to the image-block based on the frame motion data, the image-block including a subset of the regions of the particular image frame.

5. The device of claim 4, wherein the processor is configured to generate the predicted background image-block based on determining that the image-block motion data fails to satisfy a motion threshold.

6. The device of claim 4, wherein the processor is configured to store at least one of the background image-block corresponding to the image-block or the foreground image-block corresponding to the image-block at the memory buffer.

7. The device of claim 4, wherein the processor is configured, based on determining that the image-block motion data satisfies a motion threshold and that region motion data corresponding to one or more regions within the image-block fails to satisfy the motion threshold, to:
determine background regions of the image-block corresponding to the one or more regions and foreground regions of the image-block corresponding to the remaining regions of the image-block; and
generate the background image-block based on the background regions of the image-block and the one or more of the background image-blocks,
wherein the foreground image-block includes the foreground regions of the image-block.

8. The device of claim 4, wherein the processor is configured, based on determining that the image-block motion data satisfies a motion threshold and that region motion data corresponding to each region within the image-block satisfies the motion threshold, to store the image-block at the memory buffer as the foreground image-block corresponding to the image-block.

9. The device of claim 1, further comprising one or more cameras, coupled to the processor, configured to generate the video stream.

10. The device of claim 1, further comprising a security camera configured to generate the video stream, wherein the processor is further configured to perform a security analysis based on the at least one of the foreground image-block or the background image-block.

11. The device of claim 10, wherein the processor is configured to generate an alert message based on determining, during the security analysis, that one or more characteristics of the foreground image-block satisfy at least one alert criterion.

12. The device of claim 11, further comprising a display configured to output the alert message, the foreground image-block, or both.

13. The device of claim 1, further comprising a transmitter configured, in response to determining that one or more characteristics of the foreground image-block satisfy at least one criterion, to send at least the foreground image-block to a second device.

14. The device of claim 1, wherein the processor is further configured to extract at least one of the background image-block or the foreground image-block from the image-block using image decomposition techniques.

15. The device of claim 1, wherein the processor is further configured to:
generate a second predicted background image-block independently of generating the predicted background image-block; and
extract from a corresponding second image-block of the particular image frame, based on the second predicted background image-block, at least one of a second background image-block corresponding to the second image-block or a second foreground image-block corresponding to the second image-block.

16. A method of video processing comprising:
storing, at a memory buffer, background image-blocks corresponding to image-blocks of a plurality of image frames of a video stream;
generating, at a device, a predicted background image-block based on one or more of the background image-blocks;
determining, at the device, a background prediction error based on a comparison of the predicted background image-block and a corresponding image-block of a particular image frame;
determining, at the device, whether the background prediction error is greater than a threshold; and
based on determining that the background prediction error is greater than the threshold, extracting from the image-block at least one of a background image-block corresponding to the image-block or a foreground image-block corresponding to the image-block.

17. The method of claim 16, further comprising partitioning, at the device, the particular image frame into multiple image-blocks prior to generating the predicted background image-block, the multiple image-blocks including the image-block.

18. The method of claim 16, further comprising, based on determining that the background prediction error is less than or equal to the threshold, storing the predicted background image-block at the memory buffer as the background image-block corresponding to the image-block.

19. The method of claim 16, further comprising, based on determining that the background prediction error is less than or equal to the threshold, storing the background prediction error at the memory buffer as the foreground image-block corresponding to the image-block.

20. The method of claim 16, wherein the predicted background image-block is generated based on determining that image-block motion data corresponding to the image-block fails to satisfy a motion threshold.

21. The method of claim 20, further comprising generating frame motion data representing motion detected in regions of the particular image frame relative to corresponding regions of another image frame of the video stream, the image-block including a subset of the regions of the particular image frame, wherein the image-block motion data is based on the frame motion data.

22. The method of claim 16, further comprising, based on determining that image-block motion data corresponding to the image-block satisfies a motion threshold and that region motion data corresponding to one or more regions within the image-block fails to satisfy the motion threshold:
determining background regions of the image-block corresponding to the one or more regions and foreground regions of the image-block corresponding to the remaining regions of the image-block; and
generating the background image-block based on the background regions of the image-block and the one or more of the background image-blocks,
wherein the foreground image-block includes the foreground regions of the image-block.

23. The method of claim 16, further comprising, based on determining that image-block motion data corresponding to the image-block satisfies a motion threshold and that region motion data corresponding to each region within the image-block satisfies the motion threshold, storing the image-block at the memory buffer as the foreground image-block corresponding to the image-block.

24. The method of claim 16, further comprising generating the video stream at one or more cameras.

25. The method of claim 16, further comprising, in response to determining that one or more characteristics of the foreground image-block satisfy at least one criterion, sending at least the foreground image-block from a transmitter of the device to a second device.

26. The method of claim 16, further comprising, in response to determining that one or more characteristics of the foreground image-block satisfy at least one criterion, providing at least the foreground image-block to a display.

27. An apparatus comprising:
means for storing background image-blocks corresponding to image-blocks of a plurality of image frames of a video stream; and
means for extracting from an image-block of a particular image frame of the video stream at least one of a background image-block corresponding to the image-block or a foreground image-block corresponding to the image-block based on determining that a background prediction error is greater than a threshold, the background prediction error based on a comparison of the image-block and a predicted background image-block of the image-block, wherein the predicted background image-block is based on one or more of the background image-blocks.

28. The apparatus of claim 27, wherein the means for storing and the means for extracting are integrated into at least one of a mobile phone, a communication device, a computer, a music player, a video player, an entertainment unit, a navigation device, a personal digital assistant (PDA), a decoder, or a set top box.

29. An apparatus comprising:
means for generating a video stream; and
means for extracting from an image-block of a particular image frame of the video stream at least one of a background image-block corresponding to the image-block or a foreground image-block corresponding to the image-block based on determining that a background prediction error is greater than a threshold, the background prediction error based on a comparison of the image-block and a predicted background image-block of the image-block, wherein the predicted background image-block is based on one or more of a plurality of background image-blocks, and wherein the plurality of background image-blocks correspond to image-blocks of a plurality of image frames of the video stream.

30. The apparatus of claim 29, wherein the means for generating and the means for extracting are integrated into at least one of a mobile phone, a communication device, a computer, a music player, a video player, an entertainment unit, a navigation device, a personal digital assistant (PDA), a decoder, or a set top box.
